(19) United States
(12) Patent Application Publication
(10) Pub. No.: US 2023/0418972 A1
(43) Pub. Date: Dec. 28, 2023

(54) DISTRIBUTION MANAGEMENT DEVICE, DISTRIBUTION MANAGEMENT SYSTEM, AND DISTRIBUTION MANAGEMENT METHOD

(71) Applicant: NEC Corporation, Minato-ku, Tokyo (JP)

(72) Inventor: Tsuyoshi Morita, Tokyo (JP)

(73) Assignee: NEC Corporation, Minato-ku, Tokyo (JP)

(21) Appl. No.: 18/037,273

(22) PCT Filed: Nov. 27, 2020
(86) PCT No.: PCT/JP2020/044326

§ 371 Date: May 16, 2023

(51) Int. Cl. G06F 21/62; H04L 9/40

(52) U.S. Cl. CPC G06F 21/6245; H04L 63/04

(57) ABSTRACT

Provided is a technique for appropriately distributing information to be protected. A distribution management apparatus (1) includes: an acquisition means (22) that acquires distribution consent data (110) indicating that a user consents to an information holding apparatus (2) transmitting, in a case where a distribution condition, which is predetermined, is fulfilled, protection target information (210) to an information using apparatus (3) that uses the protection target information, the information holding apparatus holding the protection target information, which pertains to the user and is to be protected; and a distribution activation means (24) that, in a case where the distribution condition which is indicated by the acquired distribution consent data is fulfilled, permits the information holding apparatus to transmit the protection target information to the information using apparatus.

### TECHNICAL FIELD

The present invention relates to a technique for distributing information to be protected.

### BACKGROUND ART

Patent Literature 1 discloses a technique for distributing information to be protected. A personal information distribution company apparatus 200 disclosed in Patent Literature 1 receives, from a personal information apparatus 100, personal information and a condition for provision of the personal information. In response to a request from a personal information using company apparatus 300, the personal information distribution company apparatus 200 extracts personal information that matches the condition, gives an authentication code to the personal information, and transmits the personal information to the personal information using company apparatus 300.

### CITATION LIST

### Patent Literature

[Patent Literature 1]
Japanese Patent Application Publication Tokukai No. 2016-91067

### SUMMARY OF INVENTION

### Technical Problem

The technique disclosed in Patent Literature 1 requires a user to transmit, from the personal information apparatus 100 to the personal information distribution company apparatus 200, information that is held by the personal information apparatus 100 and that is to be protected, specifically, personal information. That is, in order to distribute the personal information to the personal information using company apparatus 300, the user needs to temporarily deposit the personal information in the personal information distribution company apparatus 200.

In such a technique, first, a risk such as falsification, spoofing, or interception occurs when the personal information is transmitted so as to be deposited in the personal information distribution company apparatus 200. Next, even after the personal information is deposited, a risk of leakage of the personal information occurs due to, for example, an attack on the personal information distribution company apparatus 200 from a malicious external apparatus. In other words, the user who uses the technique unfortunately needs to bear a risk of leakage of personal information in an undesired manner.

An example aspect of the present invention has been made in view of the problems described earlier, and an example object thereof is to provide a technique for appropriately distributing information to be protected.

### Solution to Problem

A distribution management apparatus in accordance with an aspect of the present invention includes: an acquisition means that acquires distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and a distribution activation means that, in a case where the distribution condition which is indicated by the acquired distribution consent data is fulfilled, permits the information holding apparatus to transmit the protection target information to the information using apparatus.

A distribution management system in accordance with an aspect of the present invention includes: an information holding apparatus that holds protection target information, which pertains to a user and is to be protected; an information using apparatus that uses the protection target information; a storage apparatus that stores distribution consent data indicating that the user consents to the information holding apparatus transmitting the protection target information to the information using apparatus in a case where a distribution condition, which is predetermined, is fulfilled; and a distribution management apparatus, the distribution management apparatus including: an acquisition means that acquires the distribution consent data from the storage apparatus; and a distribution activation means that, in a case where the distribution condition which is indicated by the distribution consent data is fulfilled, permits the information holding apparatus to transmit the protection target information to the information using apparatus.

A distribution management method in accordance with an aspect of the present invention is configured such that: a distribution management apparatus acquires distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and in a case where the distribution condition which is indicated by the acquired distribution consent data is fulfilled, the distribution management apparatus permits the information holding apparatus to transmit the protection target information to the information using apparatus.

### Advantageous Effects of Invention

An example aspect of the present invention makes it possible to appropriately distribute information to be protected.

### BRIEF DESCRIPTION OF DRAWINGS

FIG. 1 is a block diagram illustrating a configuration of a distribution management apparatus of a first example embodiment of the present invention.

FIG. 2 is a flowchart showing a flow of a distribution management method of the first example embodiment of the present invention.

FIG. 3 is a block diagram illustrating a configuration of a distribution management system of the first example embodiment of the present invention.

FIG. 4 is a data structure diagram illustrating a data structure of distribution consent data of the first example embodiment of the present invention.

FIG. 5 is a block diagram illustrating a configuration of a distribution management system of example embodiments of the present invention.

FIG. 6 is a block diagram illustrating a configuration of a distribution management apparatus of the example embodiments of the present invention.

FIG. 7 is a data structure diagram illustrating a data structure of a distribution consent database of a second example embodiment of the present invention.

FIG. 8 is a sequence diagram showing a flow of a distribution management method of the example embodiments of the present invention.

FIG. 9 is a data structure diagram illustrating an example of a data structure of a distribution permit of the example embodiments of the present invention.

FIG. 10 is a flowchart showing an example of a flow of a process of the example embodiments of the present invention for determining fulfillment or nonfulfillment of a distribution condition, the process being carried out by a determination unit.

FIG. 11 is a data structure diagram illustrating a data structure of a distribution consent database of a third example embodiment of the present invention.

FIG. 12 is a data structure diagram illustrating a data structure of a distribution consent database of a fourth example embodiment of the present invention.

FIG. 13 is a block diagram illustrating an example of a hardware configuration of a distribution management apparatus of the example embodiments of the present invention.

### EXAMPLE EMBODIMENTS

### First Example Embodiment

A first example embodiment of the present invention will be described in detail with reference to the drawings. The first example embodiment is a basic form of example embodiments described later.

<Configuration of the Distribution Management Apparatus>

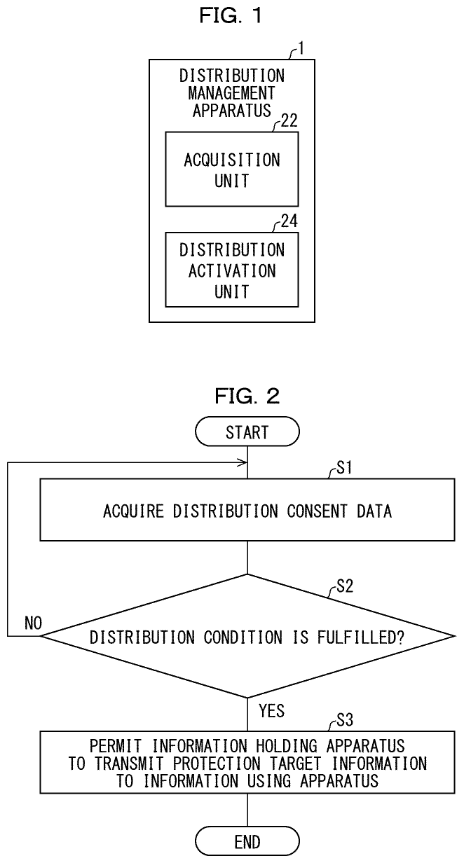

A configuration of a distribution management apparatus 1 in accordance with the first example embodiment will be described with reference to FIG. 1. FIG. 1 is a block diagram illustrating a configuration of the distribution management apparatus 1. The distribution management apparatus 1 is an apparatus which manages distribution of information to be protected so that the information to be protected is appropriately distributed. In the following description, the information to be protected is referred to as protection target information. Furthermore, transmission of the protection target information from one to the other of apparatuses is referred to as “distribution”.

The distribution management apparatus 1 includes an acquisition unit 22 and a distribution activation unit 24 (see FIG. 1). The acquisition unit 22 is configured to achieve an acquisition means in the first example embodiment. The distribution activation unit 24 is configured to achieve a distribution activation means in the first example embodiment.

The acquisition unit 22 acquires distribution consent data. The distribution consent data indicates that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected. For example, the distribution consent data is registered in advance in a storage apparatus before an event that fulfills the predetermined distribution condition occurs. The storage apparatus that stores the distribution consent data may be provided in the distribution management apparatus 1, or may be provided in an apparatus which is different from the distribution management apparatus 1 and which is accessible by the distribution management apparatus 1, such as a cloud server.

In a case where the distribution condition that is indicated by the acquired distribution consent data (described earlier) is fulfilled, the distribution activation unit 24 permits the information holding apparatus to transmit the protection target information to the information using apparatus.

Specifically, in accordance with the acquired distribution consent data, the distribution activation unit 24 permits the information holding apparatus that is indicated by the distribution consent data to transmit, to the information using apparatus that is indicated by the distribution consent data, the protection target information that is held by the information holding apparatus.

<Flow of Distribution Management Method>

A flow of a distribution management method in accordance with the first example embodiment will be described with reference to FIG. 2. FIG. 2 is a flowchart showing a flow of processes of the distribution management method which is carried out by the distribution management apparatus 1. The distribution management method may include at least a step S1 and a step S3, and, if necessary, may include a step S2 (see FIG. 2).

In the step S1, the acquisition unit 22 acquires the distribution consent data. For example, the acquisition unit 22 refers to the storage apparatus and reads the distribution consent data that is stored in the storage apparatus.

In the step S2, it is determined whether the distribution condition that is indicated by the acquired distribution consent data is fulfilled. Note that a determination unit 23 (described later) of the distribution management apparatus 1 may determine fulfillment or nonfulfillment of the distribution condition. In another example, the distribution activation unit 24 may receive, from another apparatus or another component of the distribution management apparatus 1, a notification that the distribution condition is fulfilled. The distribution management apparatus 1 that has confirmed that the distribution condition is fulfilled proceeds with the process from YES in S2 to S3.

In the step S3, in a case where the distribution condition that is indicated by the acquired distribution consent data is fulfilled, the distribution activation unit 24 permits the information holding apparatus to transmit the protection target information to the information using apparatus.

<Configuration of Distribution Management System>

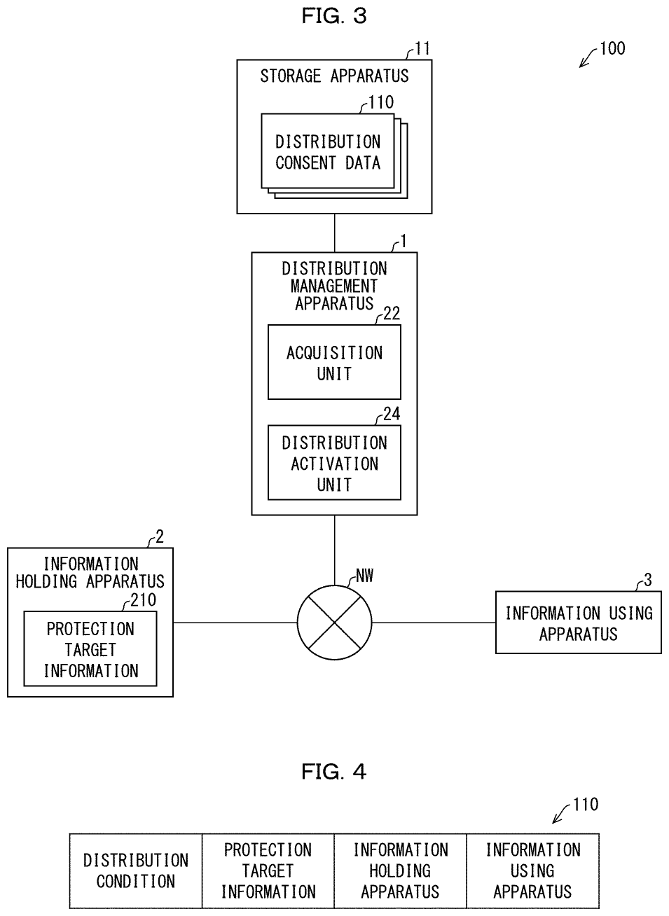

An overall configuration of a distribution management system in accordance with the first example embodiment will be described with reference to FIG. 3. FIG. 3 is a block diagram illustrating an overall configuration of a distribution management system 100 including the distribution management apparatus 1.

The distribution management system 100 includes an information holding apparatus 2, an information using apparatus 3, a storage apparatus 11, and the distribution management apparatus 1 (see FIG. 3). The information holding apparatus 2 is an apparatus that holds protection target information 210 which pertains to the user and which is to be protected. The information using apparatus 3 is an apparatus that uses the protection target information 210 and that is a proper receiver of the protection target information 210. The storage apparatus 11 is an apparatus that stores distribution consent data 110. The distribution consent data 110 is information indicating that the user consents to the information holding apparatus 2 transmitting the protection target information 210 to the information using apparatus 3 in a case where the predetermined distribution condition is fulfilled.

The distribution management apparatus 1 includes the acquisition unit 22 that acquires the distribution consent data 110 from the storage apparatus 11 and the distribution activation unit 24 that, in a case where the distribution condition that is indicated by the distribution consent data 110 is fulfilled, permits the information holding apparatus 2 to transmit the protection target information 210 to the information using apparatus 3.

For example, the distribution management apparatus 1 and the information holding apparatus 2 are communicably connected via a communication network NW such as the Internet. The information holding apparatus 2 and the information using apparatus 3 are communicably connected via a communication network that is identical to or different from the communication network NW mentioned above. The distribution management apparatus 1 and the information using apparatus 3 may also be connected via the communication network NW. The distribution management apparatus 1 and the storage apparatus 11 may be connected via a communication network that is a private dedicated line or is identical to the communication network NW mentioned earlier. In a case where a public network such as the Internet is included between the distribution management apparatus 1 and the storage apparatus 11, a virtual private network (VPN) may be provided between the distribution management apparatus 1 and the storage apparatus 11 in consideration of safety.

<Data Structure of Distribution Consent Data>

In the distribution management system 100 in accordance with the first example embodiment, a data structure of the distribution consent data 110 that is stored in the storage apparatus 11 will be described with reference to FIG. 4. FIG. 4 is a data structure diagram illustrating an example of the data structure of the distribution consent data 110.

The distribution consent data 110 is, for example, configured to include the following items: a distribution condition, protection target information, an information holding apparatus, and an information using apparatus (see FIG. 4).

The item “distribution condition” defines a condition under which the user consents to provision of the protection target information 210 to the information using apparatus 3. The user can specify, for example, one or more certain events as a distribution condition under which the protection target information 210 may be distributed. One or more events specified by the user may be defined as the distribution condition. In this case, upon occurrence of an event defined as the distribution condition, the distribution activation unit 24 permits distribution of the protection target information 210.

The item “protection target information” defines the protection target information 210 to which consent to provision to the information using apparatus 3 has been given and which is to be distributed. For example, the user can specify information that determines the protection target information 210, such as a type, a name, and an identification number of the protection target information 210. For example, the type of the protection target information 210 such as an “address”, a “name”, and/or a “telephone number” may be defined in the item “protection target information”. Alternatively, for example, a name of a document or a document form that includes personal information of the user, such as a “copy of family register”, a “medical certificate”, a “certificate of absence from work”, a “parking certificate”, a “medical expenses receipt”, and/or a “pay slip” may be defined in the item “protection target information”.

The item “information holding apparatus” defines the information holding apparatus 2 that prepares or holds the protection target information 210 which is defined by the item “protection target information”. Information that is specific to the information holding apparatus 2 and that uniquely determines the information holding apparatus 2 is defined in the item “information holding apparatus”. Examples of the information that is specific to the information holding apparatus 2 include an apparatus ID, an IP address, and an apparatus name.

The item “information using apparatus” defines the information using apparatus 3 to which the user consents as the proper receiver of the protection target information 210 that is defined in the item “protection target information”. Information that is specific to the information using apparatus 3 is defined in the item “information using apparatus”. As in the case of the information holding apparatus 2, examples of the information that is specific to the information using apparatus 3 include an apparatus ID, an IP address, and an apparatus name.

For example, the acquisition unit 22 of the distribution management apparatus 1 reads, from the storage apparatus 11, the distribution consent data 110 illustrated in FIG. 4. In a case where the distribution condition that is defined in the read distribution consent data 110 is fulfilled, the distribution activation unit 24 permits distribution of the protection target information 210 that is defined in the distribution consent data 110. Specifically, the distribution activation unit 24 permits the information holding apparatus 2 that is indicated by the distribution consent data 110 to transmit the protection target information 210 (described earlier) to the information using apparatus 3 that is indicated by the distribution consent data 110.

With this, as specified in the distribution consent data 110, the protection target information 210 is safely provided from the information holding apparatus 2 to the information using apparatus 3 at a required timing.

### Effect of First Example Embodiment

As described above, according to the distribution management apparatus 1, the distribution management method, and the distribution management system 100 in accordance with the first example embodiment, the acquisition unit 22 of the distribution management apparatus 1 acquires the distribution consent data 110 that is registered in advance in the storage apparatus 11 of the distribution management apparatus 1 or the storage apparatus 11 of an external apparatus. In a case where the distribution condition that is indicated by the acquired distribution consent data 110 is fulfilled, the distribution activation unit 24 permits the information holding apparatus 2 to transmit the protection target information 210 to the information using apparatus 3.

In response to permission for transmission of the protection target information 210, the information holding apparatus 2 that holds the protection target information 210 is allowed to transmit the protection target information 210 to the information using apparatus 3. Note that as a matter of course, an information protection technique in which an electronic signature, a password, and/or the like is/are used can be employed to transmit and receive the protection target information 210. Thus, fulfillment of the distribution condition triggers safe provision of the protection target information 210 from the information holding apparatus 2 to the information using apparatus 3 that requires the protection target information 210.

The distribution management apparatus 1 manages, in accordance with the distribution consent data 110, (i) a timing at which the protection target information 210 is distributed, (ii) a source from which the protection target information 210 is provided, and (iii) a destination to which the protection target information 210 is provided. The distribution management apparatus 1 does not hold the protection target information 210. The protection target information 210 remains held in the information holding apparatus 2, which is a place where the protection target information 210 is originally kept. In other words, the user does not need to deposit an important piece of the protection target information 210 in the distribution management apparatus 1. This brings about an effect such that the user escapes a risk of falsification or interception of the protection target information 210 which is being deposited, or a risk of leakage of the protection target information 210 which is aggregated in a destination apparatus where the protection target information 210 is deposited.

As described above, the distribution management apparatus 1, the distribution management method, and the distribution management system 100 in accordance with the first example embodiment releases the user from such a risk as described earlier. Control of the distribution management apparatus 1 causes the protection target information 210 distribution of which as the distribution consent data has been given consent to be safely provided, at a required timing, to the information using apparatus 3 that requires the protection target information 210. That is, the user is released from a complicated procedure in which the user needs to give consent every time distribution of the protection target information 210 occurs.

It is generally natural that the user should not wish or should fear to deposit the important protection target information 210 in an apparatus different from the information holding apparatus 2. However, an apparatus, a method, and a system in accordance with the first example embodiment eliminates such a psychological burden on the user. This enables the user to feel safe to use the distribution management system 100 that is highly convenient and that does not require any complicated procedure to be carried out.

### Second Example Embodiment

A second example embodiment of the present invention will be described in detail with reference to the drawings. Note that members having functions identical to those of the respective members described in the first example embodiment are given respective identical reference numerals, and a description of those members is omitted as appropriate.

<Configuration of Distribution Management System>

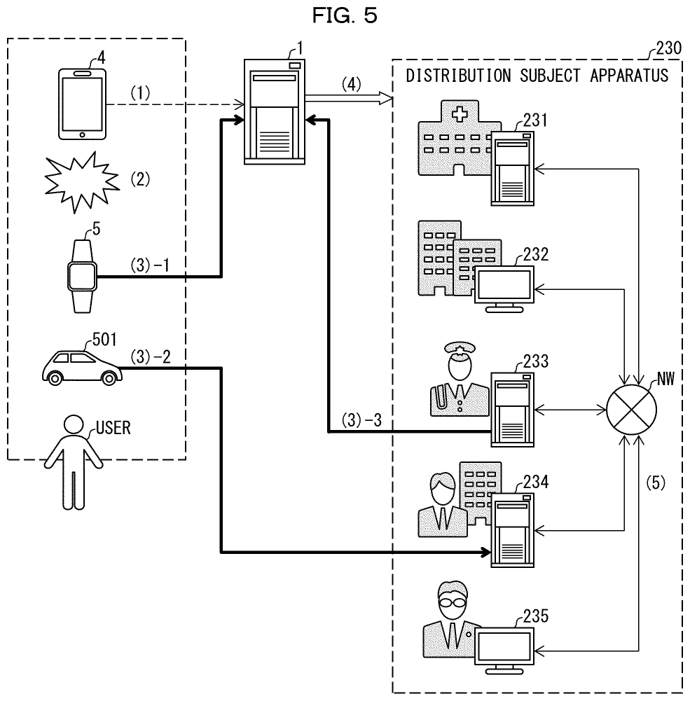

An overall configuration of a distribution management system 100 in accordance with the second example embodiment will be described with reference to FIG. 5. FIG. 5 is a block diagram illustrating the overall configuration of the distribution management system 100 including a distribution management apparatus 1. The distribution management system 100 in accordance with the second example embodiment is applied as a system that allows a user who has become a victim of a traffic accident to appropriately distribute protection target information 210 of the user to parties concerned.

The distribution management system 100 in accordance with the second example embodiment includes an information holding apparatus 2, an information using apparatus 3, a storage apparatus 11, and the distribution management apparatus 1.

In the second example embodiment, it is assumed that the storage apparatus 11 is provided in the distribution management apparatus 1. In the following description, the information holding apparatus 2 and the information using apparatus 3 that transmit and receive the protection target information 210 are collectively referred to as a “distribution subject apparatus” as a subject that carries out distribution. The distribution management system 100 includes a plurality of distribution subject apparatuses 230 in the second example embodiment (see FIG. 5). A distribution subject apparatus 230 functions as at least one of the information holding apparatus 2 and the information using apparatus 3. That is, a first distribution subject apparatus 230 functions as the information holding apparatus 2 when transmitting, to a second distribution subject apparatus 230, the protection target information 210 that the first distribution subject apparatus 230 holds, and functions as the information using apparatus 3 when receiving the protection target information 210 from the second distribution subject apparatus 230.

In the second example embodiment, it is assumed, for example, that the distribution management apparatus 1 and each of the distribution subject apparatuses 230 can communicate with each other via a communication network NW and that the distribution subject apparatuses 230 can also communicate with each other via the communication network NW.

In the second example embodiment, it is assumed, for example, that the distribution subject apparatuses 230 are a medical institution apparatus 231, a workplace apparatus 232, a public institution apparatus 233 that manages an accident, an insurance company apparatus 234, and a law office apparatus 235 (see FIG. 5). The public institution apparatus 233 is an information processing apparatus that belongs to a public institution which controls traffic, such as a police station and an automobile safety driving center.

In the second example embodiment of the present invention, the distribution management system 100 further includes a user peripheral device that is possessed by the user (see FIG. 5). Examples of the user peripheral device include a user apparatus 4, a wearable terminal 5 as an external apparatus, and an external apparatus 501 other than the wearable terminal 5. Such a user peripheral device is communicably connected with the distribution management apparatus 1 via the communication network NW. The user peripheral device may be communicably connected as needed to some of the distribution subject apparatuses 230 via the communication network NW or another communication network.

The user apparatus 4 is an apparatus for assisting the user in registering the distribution consent data 110 in the storage apparatus 11. The user apparatus 4 is, for example, a smartphone.

The external apparatus is a communication apparatus that is configured outside the distribution management apparatus 1. The external apparatus detects that a certain event has occurred, and transmits, to the distribution management apparatus 1 via a communication network such as the communication network NW, event occurrence information for notifying that the certain event has occurred. The wearable terminal 5 and the external apparatus 501 are examples of the external apparatus. The user apparatus 4 may function as the external apparatus that gives notice of the event occurrence information.

The wearable terminal 5 is an apparatus that can be worn by the user. The wearable terminal 5 includes, for example, a sensor that measures a physical quantity related to a body of the user, or a physical quantity related to an environment surrounding the user. Furthermore, the wearable terminal 5 may detect occurrence of a specific event in accordance with a predetermined physical quantity measured by the sensor. The wearable terminal 5 may transmit, to the distribution management apparatus 1, the event occurrence information including the measured physical quantity.

The physical quantity measured by the wearable terminal is exemplified by but not limited to acceleration. By detecting acceleration, it is possible to detect a possibility that motion which leads to an accident, such as an impact, a fall, or a sudden movement has occurred in the user who wears the wearable terminal 5. In addition, the wearable terminal 5 may measure an activity level (the number of steps, the number of steps climbed up and down, a distance traveled, the number of calories consumed, etc.) of the user and vital data (a heart rate, a blood pressure, a body temperature, a blood oxygen level, a body weight, etc.) of the user.

The external apparatus 501 is an external apparatus different from the wearable terminal 5 and is, for example, an event data recorder mounted on an automobile driven by the user. The external apparatus 501 is triggered by an impact etc. received by the automobile to transmit, to another apparatus, video data obtained by photographing with a camera. In the example illustrated in FIG. 5, the external apparatus 501 transmits the video data to one of the distribution subject apparatuses 230. Note, however, that the external apparatus 501 may alternatively transmit, to the distribution management apparatus 1, the video data as the event occurrence information.

In the distribution management system 100, information processing is generally carried out as below.

(1) A request for registration of the distribution consent data 110 is transmitted from the user apparatus 4 to the distribution management apparatus 1. The distribution management apparatus 1 registers the distribution consent data 110 in the storage apparatus 11 in accordance with the request. The distribution consent data 110 is registered in the storage apparatus 11 before a traffic accident of (2) occurs.

(2) The traffic accident occurs.

(3) In response to occurrence of an accident, the event occurrence information is transmitted from the external apparatus to the distribution management apparatus 1. For example, the wearable terminal 5 transmits, to the distribution management apparatus 1, the event occurrence information indicating that an impact has been detected ((3)-1). The external apparatus 501 (event data recorder) may transmit, to the insurance company apparatus 234, the video data that has been recorded before and after the impact ((3)-2). The public institution apparatus 233 transmits, to the distribution management apparatus 1, an accident certificate as the event occurrence information ((3)-3). In the second example embodiment, it is assumed, for example, that an operating company that operates the distribution management apparatus 1 and a public institution that possesses the public institution apparatus 233 conclude, in advance, a contract to supply the accident certificate to the distribution management apparatus 1 in a case where the accident occurs. In this case, the public institution apparatus 233 functions as the external apparatus that supplies the event occurrence information to the distribution management apparatus 1.

(4) In a case where a distribution condition is fulfilled, in accordance with the distribution consent data 110, the distribution management apparatus 1 permits the information holding apparatus 2 to transmit the protection target information 210.

(5) Among the distribution subject apparatuses 230, the information holding apparatus 2 that has been permitted to transmit the protection target information 210 transmits the protection target information 210 to the information using apparatus 3 that is recognized as a proper receiver. In this way, the protection target information 210 is distributed among the distribution subject apparatuses 230 via the communication network NW.

<Configuration of Distribution Management Apparatus>

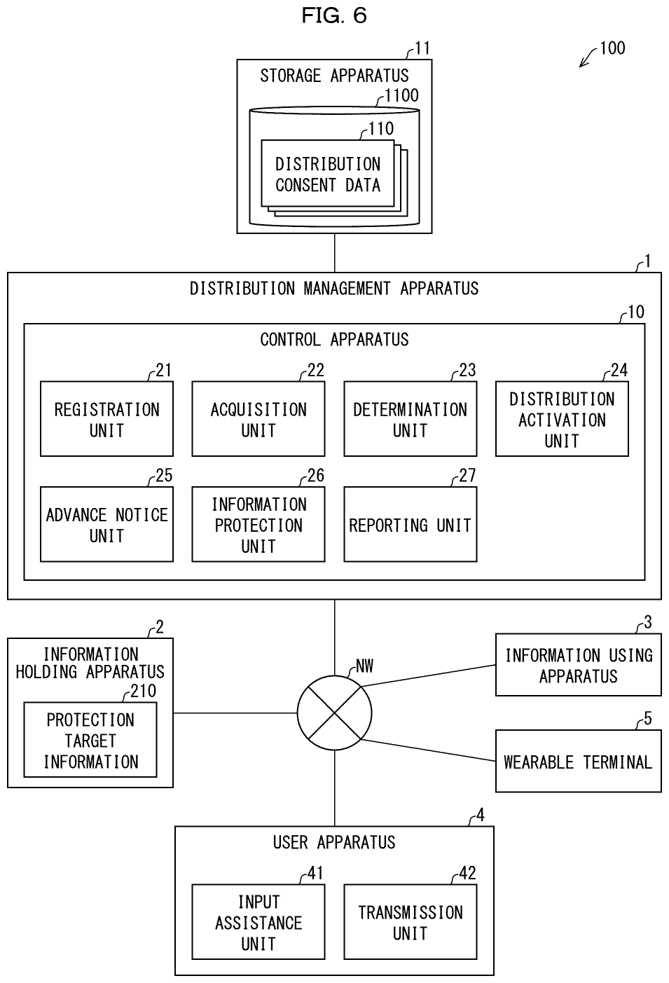

A configuration of the distribution management apparatus 1 in accordance with the second example embodiment will be described with reference to FIG. 6. FIG. 6 is a block diagram illustrating the configuration of the distribution management apparatus 1.

The distribution management apparatus 1 in accordance with the second example embodiment includes a control apparatus 10 and the storage apparatus 11. The distribution management apparatus 1 includes a communication apparatus (not illustrated) for communication via the communication network NW of another apparatus.

The control apparatus 10 is constituted by a computing apparatus such as a central processing unit (CPU) or a dedicated processor. Each unit (described later with reference to FIG. 6) of the control apparatus 10 can be realized by the computing apparatus (described above) reading, into a random access memory (RAM), a program that is stored in a storage apparatus (e.g., the storage apparatus 11) which is realized by a read only memory (ROM) or the like, and carrying out the program.

The storage apparatus 11 stores various data used in the control apparatus 10. In the second example embodiment, the storage apparatus 11 store, in a non-volatile manner, a distribution consent database 1100 (hereinafter referred to as a consent DB 1100) for registering a plurality of pieces of the distribution consent data 110. The storage apparatus 11 may be configured as an external storage apparatus that can be accessed by the distribution management apparatus 1.

The control apparatus 10 may include not only the acquisition unit 22 and the distribution activation unit 24 that have been described in the first example embodiment but also some or all of a registration unit 21, a determination unit 23, an advance notice unit 25, an information protection unit 26, and a reporting unit 27. The registration unit 21 is configured to achieve a registration means in the second example embodiment. The determination unit 23 is configured to achieve a determination means in the second example embodiment. The advance notice unit 25 is configured to achieve an advance notice means in the second example embodiment. The information protection unit 26 is configured to achieve an information protection means in the second example embodiment. The reporting unit 27 is configured to achieve a reporting means in the second example embodiment.

In response to the user having consented, under a predetermined distribution condition, to distribution of the protection target information 210, the registration unit 21 registers the distribution consent data 110 in the storage apparatus 11. In the second example embodiment, for example, the registration unit 21 receives, from the user apparatus 4 operated by the user, a notification that the user consents to the information holding apparatus 2 transmitting the protection target information 210 to the information using apparatus 3 in a case where the distribution condition is fulfilled. Upon receiving the notification, the registration unit 21 generates the distribution consent data 110 and registers the distribution consent data 110 in the storage apparatus 11. The registration unit 21 registers the distribution consent data 110 in the storage apparatus 11 in advance before the distribution condition is actually fulfilled.

The determination unit 23 determines fulfillment of the distribution condition that is defined in the distribution consent data 110 which has been registered in advance. Specifically, the determination unit 23 determines fulfillment or nonfulfillment of the distribution condition in accordance with one or more pieces of the event occurrence information that has been transmitted from one or more external apparatuses and that gives notice of occurrence of an event. In the second example embodiment, for example, a plurality of events are defined as the distribution condition in one piece of the distribution consent data 110. The determination unit 23 determines fulfillment of the distribution condition in a case where a plurality of pieces of the event occurrence information which pieces have been received from a respective plurality of external apparatuses are correlated with each other.

The expression “a plurality of pieces of the event occurrence information are correlated with each other” means that the plurality of pieces of the event occurrence information have been generated due to a single incident which happened to a single user. It is assumed, for example, that a first event and a second event are defined as the distribution condition in one piece of the distribution consent data 110.

It is assumed that the determination unit 23 receives first event occurrence information and receives second event occurrence information within a certain time period after receiving the first event occurrence information. In this case, the determination unit 23 may (i) determine a correlation between the first event occurrence information and the second event occurrence information in accordance with temporal closeness between the first event occurrence information and the second event occurrence information and (ii) determine fulfillment of the distribution condition.

Furthermore, the event occurrence information may include user information for determining the user who has become a party to the event, the user information being specific to the user. In this case, the determination unit 23 refers to (i) the user information that is included in the first event occurrence information which has been received from a certain external apparatus and (ii) the user information that is included in the second event occurrence information which has been received from the certain external apparatus or another external apparatus different from the certain external apparatus. In a case where these pieces of the user information refer to a single user, the determination unit 23 may (i) determine the correlation between the first event occurrence information and the second event occurrence information and (ii) determine fulfillment of the distribution condition.

In response to permission by the distribution activation unit 24 for distribution of the protection target information 210, the advance notice unit 25 gives, to the information using apparatus 3, which is a receiver of the protection target information 210, advance notice that the protection target information 210 will be transmitted from the information holding apparatus 2.

The information protection unit 26 that does not receive a reception completion notification from the information using apparatus 3 within a certain time period after the distribution activation unit 24 gives the information holding apparatus 2 permission for transmission of the protection target information 210 cancels the permission given to the information holding apparatus 2 for transmission of the protection target information 210. The reception completion notification is a notification indicating that the information using apparatus 3 has safely received the protection target information 210 from the information holding apparatus 2.

In response to permission by the distribution activation unit 24 for transmission of the protection target information 210 to the information holding apparatus 2, the reporting unit 27 reports, to the user apparatus 4 which is operated by the user, that transmission of the protection target information 210 has been permitted.

<Configuration of User Apparatus>

In the second example embodiment, the user apparatus 4 may include an input assistance unit 41 and a transmission unit 42 (see FIG. 6). The input assistance unit 41 is configured to achieve an input assistance means in the second example embodiment. The transmission unit 42 is configured to achieve a registration means of the user apparatus 4 in the second example embodiment.

The input assistance unit 41 assists in an input operation for the user registering the distribution consent data 110 in the storage apparatus 11 in advance. Specifically, the input assistance unit 41 provides the user with a user interface (UI) for allowing the user to give an answer as to whether the user will consent to the information holding apparatus 2 transmitting the protection target information 210 to the information using apparatus 3 in a case where the distribution condition is fulfilled.

The transmission unit 42 transmits, to the distribution management apparatus 1, the answer of the user which answer has been input via the UI. In a case where the answer of the user indicates consent to distribution, the transmission unit 42 transmits the answer to the distribution management apparatus 1 so as to request the distribution management apparatus 1 to register the distribution consent data 110. Before the distribution condition is actually fulfilled, the transmission unit 42 requests of the distribution management apparatus 1 in advance that the distribution consent data 110 be registered in the storage apparatus 11.

The transmission unit 42 desirably transmits, to the distribution management apparatus 1, the answer of the user to which answer an electronic signature of the user, such as a hash value is added.

In the second example embodiment, the input assistance unit 41 accesses a web site or the like operated by the distribution management apparatus 1, and causes a display unit (not illustrated) of the user apparatus 4 to display a UI screen through a web browser. For example, the UI screen may be designed to present, to the user, a question requesting consent, and cause the user to give an answer as to whether to give consent. The input assistance unit 41 may cause the display unit of the user apparatus 4 to display the UI screen in which a question and an answer are placed. For example, the question is placed, in the UI screen, as a text “whether to consent to transmission of the protection target information 210 from the information holding apparatus 2 to the information using apparatus 3 in a case where the distribution condition is fulfilled”. Furthermore, an answer button for causing the user to select “Yes” or “No” for the question described above may be placed in the same UI screen. In a case where the user operates the user apparatus 4 and selects “Yes”, the transmission unit 42 transmits, to the distribution management apparatus 1, an answer of the user which answer indicates that distribution has been consented to. By transmitting, to the distribution management apparatus 1, the answer described above, the transmission unit 42 can request of the distribution management apparatus 1 that “the distribution condition, the protection target information 210, the information holding apparatus 2, and the information using apparatus 3” presented on the UI screen be registered as the distribution consent data 110 in the storage apparatus 11.

As another example of the UI screen, for example, a plurality of options are placed in a UI screen, which may be designed to cause the user to select the protection target information 210 distribution of which is consented to, the distribution condition under which distribution is consented to, the information holding apparatus 2, and the information using apparatus 3.

(Variation of User Apparatus 4)

The user apparatus 4 may include, as a registration means, the registration unit 21 in place of the transmission unit 42. In a case where the user apparatus 4 includes the registration unit 21, the registration unit 21 of the distribution management apparatus 1 may be omitted.

In the present variation, for example, the input assistance unit 41 and the registration unit 21 that are provided in the user apparatus 4 are provided as applications to be installed in a smartphone. In the present variation, the input assistance unit 41 and the registration unit 21 that are applications for registering the distribution consent data 110 in the storage apparatus 11 are provided in the user apparatus 4.

The input assistance unit 41 causes the display unit to display the UI screen described earlier and receives an answer as to whether the user consents to distribution. In a case where the received answer indicates that distribution is consented to, the registration unit 21 (i) generates the distribution consent data 110 including “the distribution condition, the protection target information 210, the information holding apparatus 2, and the information using apparatus 3” presented on the UI screen and (ii) registers the distribution consent data 110 in a consent DB 1100 of the storage apparatus 11. The storage apparatus 11 can be realized in, for example, a cloud server from which the distribution management apparatus 1 can read data. The registration unit 21 desirably registers, in the consent DB 1100, the distribution consent data 110 to which the electronic signature of the user, such as a hash value is added.

<Data Structure of Consent DB>

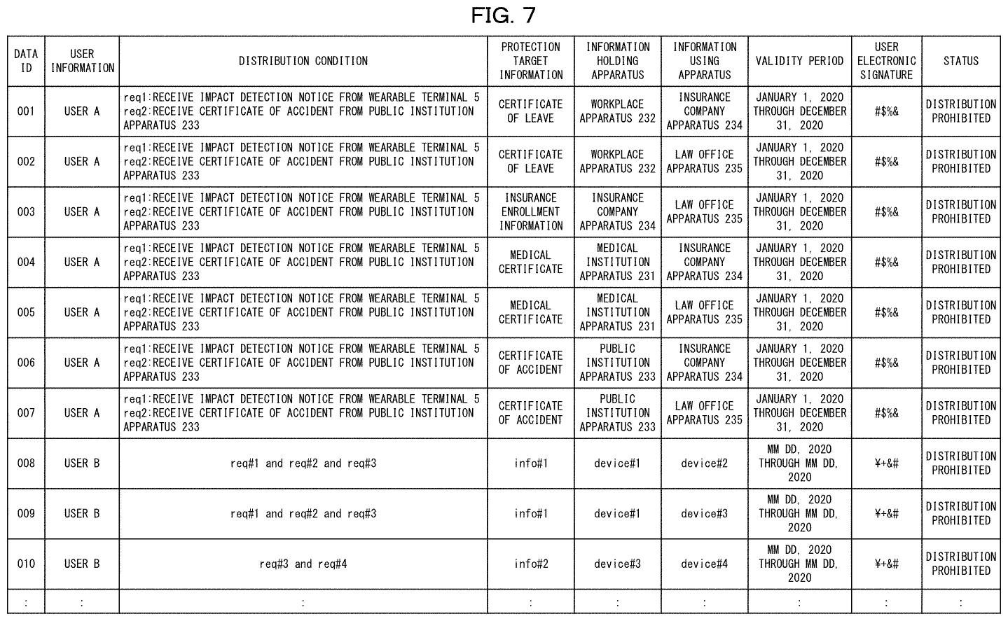

In the distribution management system 100 in accordance with the second example embodiment, a data structure of the consent DB 1100 that is stored in the storage apparatus 11 will be described with reference to FIG. 7. FIG. 7 is a data structure diagram illustrating an example of the data structure of the consent DB 1100.

The consent DB 1100 is a database that stores the plurality of pieces of the distribution consent data 110. One row (record) of the table shown in FIG. 7 indicates one piece of the distribution consent data 110.

As shown in FIG. 7, the consent DB 1100 is, for example, configured to include the following items: the distribution condition, the protection target information, the information holding apparatus, and the information using apparatus, which have been described in the first example embodiment. In the second example embodiment, the consent DB 1100 may include, in addition to the items listed above, all or some of the following items: a data ID, user information, a validity period, a user electronic signature, and a status.

The item “data ID” indicates identification information for uniquely identifying one piece of the distribution consent data 110. Even in the case of the protection target information 210 of a single user, the distribution consent data 110 is prepared for each combination of the information holding apparatus 2 and the information using apparatus 3. By providing each of the pieces of the distribution consent data 110 with a corresponding data ID, the pieces of the individual distribution consent data 110 are individually easily managed in the consent DB 1100.

The item “user information” indicates identification information for uniquely identifying the user who is a holder of the protection target information 210 to be distributed. The user information may be any information that is specific to the user. Examples of the user information include a name, a nickname, a user ID, a telephone number, and a combination thereof.

The item “validity period” indicates a period in which distribution is consented to by the user. In other words, the validity period is a period in which in accordance with the registered distribution consent data 110, the distribution activation unit 24 is allowed to permit transmission of the protection target information 210. The validity period is set by, for example, the registration unit 21. The registration unit 21 registers, in the consent DB 1100, the distribution consent data 110 with which the validity period is associated. The registration unit 21 may set the validity period in conformity with a rule that is predetermined in accordance with the type of the protection target information 210, or may set a certain period as the validity period on the basis of a registration date and time. Alternatively, the registration unit 21 may set the validity period in accordance with a period specified by the user.

The item “user electronic signature” indicates an electronic signature of the user which electronic signature is given by the user apparatus 4. A hash value stored in this item makes it possible to confirm the following: “Details of the distribution consent data 110 are based on proper consent by the user which proper consent has certainly been transmitted from the user apparatus 4”.

The item “status” is information indicative of a state of a corresponding piece of the distribution consent data 110. For example, the status may be represented in a binary format such as a flag so as to indicate whether the distribution consent data 110 is in an active state or an inactive state. The active state means that the distribution consent data 110 is valid. That is, the active state means that the distribution condition of the distribution consent data 110 is fulfilled and the protection target information 210 is in a state in which the protection target information 210 should be transmitted from the information holding apparatus 2 to the information using apparatus 3. The inactive state means that the distribution consent data 110 is invalid. That is, the inactive state means that the distribution condition of the distribution consent data 110 is not fulfilled and the protection target information 210 is not in the state in which the protection target information 210 should be transmitted from the information holding apparatus 2 to the information using apparatus 3.

In a case where the item of the status is provided in the consent DB 1100, the distribution activation unit 24 handles the status as below, for example. In a case where the determination unit 23 determines fulfillment of the distribution condition, the distribution activation unit 24 activates the distribution consent data 110 from the inactive state to the active state. Specifically, the distribution activation unit 24 updates, from “a distribution prohibited state” indicating that transmission of the protection target information 210 is prohibited to a “distribution permitted state” indicating that transmission of the protection target information 210 is permitted, a value of the status of the distribution consent data 110 including the distribution condition fulfillment of which has been determined. The distribution activation unit 24 is triggered by having received a request for permission for distribution of the protection target information 210 from any of the distribution subject apparatuses 230 to refer first to the status of the distribution consent data 110 requested. In a case where the status indicates the distribution permitted state, the distribution activation unit 24 permits the information holding apparatus 2 to transmit the protection target information 210 to the information using apparatus 3.

In another example, the item of the status may be omitted in the consent DB 1100. In this case, the distribution activation unit 24 generates a distribution permit for transmission to the information holding apparatus 2 in a case where the determination unit 23 determines fulfillment of the distribution condition. The distribution permit is information that allows the distribution management apparatus 1 to permit the information holding apparatus 2 to transmit the protection target information 210 to the information using apparatus 3. The distribution activation unit 24 may store the generated distribution permit in the storage apparatus 11 and issue the distribution permit described above to the information holding apparatus 2 in response to a request from the information holding apparatus 2 or the information using apparatus 3. Alternatively, the distribution activation unit 24 may issue the distribution permit spontaneously to the information holding apparatus 2, at a timing at which fulfillment of the distribution condition is determined, without waiting for a request from a corresponding distribution subject apparatus 230. A data structure of the distribution permit will be described later in detail with reference to another drawing.

<Flow of Distribution Management Method>

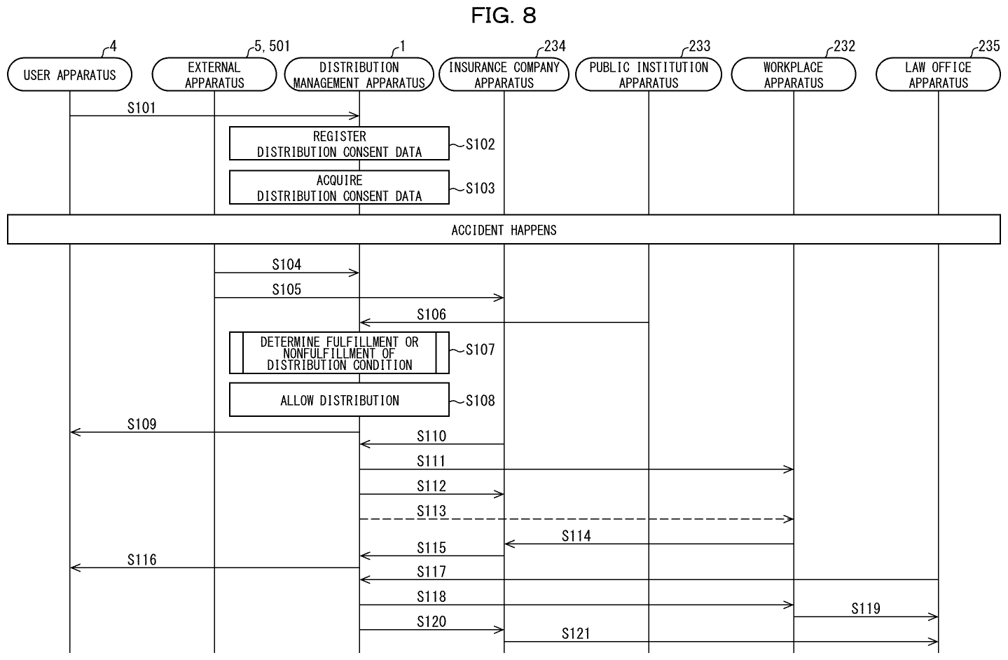

A flow of a distribution management method in accordance with the second example embodiment will be described with reference to FIG. 8. FIG. 8 is a sequence diagram showing a flow of processes of a distribution management method which processes are carried out by the apparatuses of the distribution management system 100.

(Before Emergency: Phase of Registration of Distribution Consent Data 110)

In a step S101, the transmission unit 42 of the user apparatus 4 transmits, to the distribution management apparatus 1, an answer of the user which answer has been received by the input assistance unit 41. Specifically, by transmitting, to the distribution management apparatus 1, an answer indicating that the user consents to distribution of the protection target information 210, the transmission unit 42 requests the distribution management apparatus 1 to register the distribution consent data 110 in the storage apparatus 11.

Assume, for example, that the user who has suffered a traffic accident gives consent to distribution, to the insurance company apparatus 234, a certificate of absence from work which certificate is issued by the workplace apparatus 232. In this case, the transmission unit 42 transmits, to the distribution management apparatus 1, details of the consent to which the electronic signature of the user is added.

In a step S102, the registration unit 21 of the distribution management apparatus 1 (i) generates the distribution consent data 110 that is based on the details of the consent which have been received from the user apparatus 4 and (ii) registers the distribution consent data 110 in the consent DB 1100.

For example, first, the registration unit 21 defines a plurality of events in order to accurately understand an incident such that “the user encounters a traffic accident” on the distribution management system 100. For example, the registration unit 21 defines, as distribution information, the following two events: (i) reception of an impact detection notice (the first event occurrence information) from the wearable terminal 5; and (ii) reception of an accident certificate (the second event occurrence information) from the public institution apparatus 233. Then, the registrati2on unit 21 registers the “certificate of absence from work” in the item of the protection target information, registers the workplace apparatus 232 in the item of the information holding apparatus, and registers the insurance company apparatus 234 in the item of the information using apparatus.

Thus, the distribution consent data 110 is stored in advance in the storage apparatus 11 before the incident such that the user encounters a traffic accident actually occurs.

In a step S103, the acquisition unit 22 acquires the registered distribution consent data 110 from the storage apparatus 11. In the step S103, the determination unit 23 starts monitoring fulfillment or nonfulfillment of the distribution condition that is defined in the acquired distribution consent data 110.

(After Emergency: Phase of Distribution of Protection Target Information 210)

Note here that the processes of the distribution management system 100 proceed as below after a traffic accident actually occurs.

In a step S104, the wearable terminal 5 detects an impact and transmits the impact detection notice to the distribution management apparatus 1. The wearable terminal 5 is preprogrammed to, upon detecting the impact, notify the distribution management apparatus 1 that the impact has been detected.

In a step S105, the external apparatus 501 serving as the event data recorder may transmit recorded video data to the insurance company apparatus 234. The external apparatus 501 is preprogrammed to, upon detecting an impact, transfer, to the insurance company apparatus 234, video data recorded before and after the impact.

In a step S106, the public institution apparatus 233 that functions as the external apparatus transmits the accident certificate to the distribution management apparatus 1. For example, after a police station that has been notified of an accident carries out an inspection of the scene of the accident, an automobile safety driving center that has received a request by the user may prepare the accident certificate in accordance with a report from the police station that was in charge of the inspection of the scene. Then, the public institution apparatus 233 that belongs to the automobile safety driving center transmits the prepared accident certificate to the distribution management apparatus 1.

In a step S107, the determination unit 23 of the distribution management apparatus 1 determines, in accordance with the event occurrence information that has been received from the external apparatuses, fulfillment or nonfulfillment of the distribution condition which is registered in the consent DB 1100. A fulfillment/nonfulfillment determination process for determining fulfillment or nonfulfillment of the distribution condition will be described later in detail with reference to another drawing. In a case where the determination unit 23 determines fulfillment of the distribution condition, a step S108 is carried out.

In the step S108, the distribution activation unit 24 enables distribution of the protection target information 210 in accordance with the distribution consent data 110 for which fulfillment of the distribution condition has been determined. Specifically, the distribution activation unit 24 permits the information holding apparatus 2 to transmit the protection target information 210 to the information using apparatus 3. The distribution activation unit 24 may activate the distribution consent data 110. That is, the status of the distribution consent data 110 may be updated from the “distribution prohibited state” to the “distribution permitted state”. The distribution activation unit 24 may generate the distribution permit to be transmitted to the information holding apparatus 2.

In a step S109, in response to permission by the distribution activation unit 24 for transmission of the protection target information 210 to the information holding apparatus 2, the reporting unit 27 may report, to the user apparatus 4 which is operated by the user, that transmission of the protection target information 210 has been permitted.

In a step S110, the information using apparatus 3 may transmit, to the distribution management apparatus 1, a request indicating that the information using apparatus 3, which wishes to use a piece of the protection target information 210, wishes distribution of the piece of the protection target information 210 to be permitted (a distribution permission request). For example, upon receiving, from the user, a report of an accident and a request for insurance, the insurance company apparatus 234 may transmit, to the distribution management apparatus 1, the distribution permission request indicating that the insurance company apparatus 234 wishes to use the certificate of absence from work which certificate is issued by the workplace apparatus 232. In the step S110, the workplace apparatus 232, which is the information holding apparatus 2, may transmit, to the distribution management apparatus 1, the distribution permission request for transmission of the prepared certificate of absence from work to the insurance company apparatus 234.

In a step S111, the acquisition unit 22 reads, from the storage apparatus 11, the distribution consent data 110 that is determined from the distribution permission request. In accordance with the fact that the status of the read distribution consent data 110 is the “distribution permitted state”, the distribution activation unit 24 permits and instructs the workplace apparatus 232 to transmit the certificate of absence from work to the insurance company apparatus 234. In another example, in response to the distribution permission request, the distribution activation unit 24 may transmit, to the workplace apparatus 232, the distribution permit that permits and instructs transmission of the certificate of absence from work to the insurance company apparatus 234.

In a step S112, in response to the distribution activation unit 24 having permitted distribution of the certificate of absence from work, the advance notice unit 25 may give the insurance company apparatus 234, which is a receiver of the certificate of absence from work, advance notice that the certificate of absence from work will be transmitted from the workplace apparatus 232.

In a step S113, the information protection unit 26 that does not receive the reception completion notification from the insurance company apparatus 234 within a certain time period after the distribution activation unit 24 gives the workplace apparatus 232 a permission for transmission of the certificate of absence from work cancels the permission given to the workplace apparatus 232 for transmission of the certificate of absence from work. The reception completion notification is a notification which is received from the insurance company apparatus 234 in a step S115 and which indicates that the insurance company apparatus 234 has safely received the certificate of absence from work from the workplace apparatus 232.

In a step S114, the workplace apparatus 232 transmits the certificate of absence from work to the insurance company apparatus 234 in accordance with the fact that the distribution management apparatus 1 has given permission.

In the step S115, the insurance company apparatus 234 transmits, to the distribution management apparatus 1, the reception completion notification which gives notice that the insurance company apparatus 234 has safely received the certificate of absence from work.

In a step S116, the reporting unit 27 of the distribution management apparatus 1 may further transmit, to the user apparatus 4 of the user, a distribution completion report which reports that the certificate of absence from work has been transmitted from the workplace apparatus 232 to the insurance company apparatus 234.

In a step S117 and subsequent steps, processes similar to the processes carried out in S109 to S114 are carried out with the law office apparatus 235 serving as the information using apparatus 3 and the insurance company apparatus 234 serving as the information holding apparatus 2.

That is, in the step S117, the law office apparatus 235 transmits, to the distribution management apparatus 1, the distribution permission request for requesting a piece of the protection target information 210 which piece the law office apparatus 235 requires. The law office apparatus 235 may transmit the distribution permission request described above to the distribution management apparatus 1 by being triggered by, for example, having received a request from the user. Examples of the piece of the protection target information 210 which piece the law office apparatus 235 requires include the certificate of absence from work and insurance enrollment information.

In a step S118, the distribution activation unit 24 of the distribution management apparatus 1 confirms that the status of the distribution consent data 110 a receiver of which is the law office apparatus 235 is the “distribution permitted state”. Then, the distribution activation unit 24 permits and instructs the workplace apparatus 232 to transmit the certificate of absence from work to the law office apparatus 235.

In a step S119, the workplace apparatus 232 transmits the certificate of absence from work to the law office apparatus 235 in accordance with the above-described permission and instruction.

In a step S120, in accordance with the fact that the status described earlier is the “distribution permitted state”, the distribution activation unit 24 permits and instructs the insurance company apparatus 234 to transmit the insurance enrollment information to the law office apparatus 235.

In a step S121, the insurance company apparatus 234 transmits the insurance enrollment information to the law office apparatus 235 in accordance with the above-described permission and instruction.

Also in the step S121 and subsequent steps, processes similar to the processes carried out in S109 to S121 are carried out in the distribution management system 100 in order to, for example, distribute the medical certificate from the medical institution apparatus 231 to the insurance company apparatus 234 and the law office apparatus 235. Furthermore, processes similar to the processes carried out in S109 to S121 are carried out in the distribution management system 100 in order to, for example, distribute the accident certificate from the public institution apparatus 233 to the insurance company apparatus 234 and the law office apparatus 235.

<Data Structure of Distribution Permit>

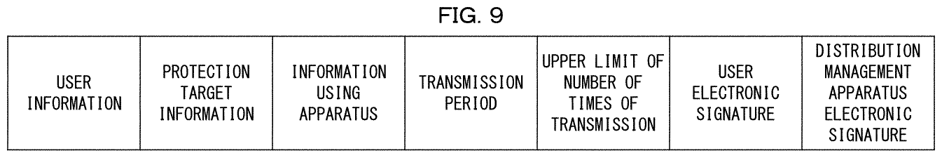

The data structure of the distribution permit that is generated by the distribution management apparatus 1 in accordance with the second example embodiment will be described with reference to FIG. 9. FIG. 9 is a data structure diagram illustrating an example of the data structure of the distribution permit. The distribution permit illustrated in FIG. 9 is, for example, generated in the step S108 by the distribution activation unit 24 of the distribution management apparatus 1 in accordance with the distribution consent data 110. The distribution permit illustrated in FIG. 9 is transmitted to and processed by the information holding apparatus 2.

The distribution permit is, for example, configured to include the following items: user information, protection target information, an information using apparatus, a transmission period, a transmission period upper limit, a user electronic signature, and a distribution management apparatus electronic signature (see FIG. 9).

The item “user information” indicates user information that determines the holder of the protection target information 210 to be distributed, that is, the user who consents to distribution of the protection target information 210. With reference to this item, the information holding apparatus 2 can determine the protection target information 210 of whom is to be distributed.

The item “protection target information” indicates the protection target information 210 to be distributed. With reference to this item, the information holding apparatus 2 can determine which piece of the protection target information 210 is to be distributed.

The item “information using apparatus” indicates the information using apparatus 3 that is a proper receiver of the protection target information 210 to be distributed. With reference to this item, the information holding apparatus 2 can determine to which information using apparatus 3 to transmit the protection target information 210.

The item “transmission period” indicates a period in which the protection target information 210 is transmitted to the information using apparatus 3. As illustrated in the drawings, the distribution activation unit 24 of the distribution management apparatus 1 sets, as this item, the transmission period in which the information holding apparatus 2 is allowed to transmit the protection target information 210. For example, the distribution activation unit 24 may set the transmission period such that the protection target information 210 is provided to the information using apparatus 3 within three days after the information holding apparatus 2 receives the distribution permit. The distribution activation unit 24 may set the transmission period in conformity with the rule that is predetermined in accordance with the type of the protection target information 210, or may set, as the transmission period, days after a certain number of days from a date and time when the distribution condition is fulfilled. The distribution activation unit 24 may alternatively set the transmission period in accordance with a fixed date that is specified by the user. The distribution activation unit 24 may alternatively set the transmission period in accordance with a fixed date that is desired by the information using apparatus 3. With reference to this item, the information holding apparatus 2 can determine by when to transmit the protection target information 210 to the information using apparatus 3.

The item “upper limit of number of times of transmission” indicates an upper limit of the number of times the information holding apparatus 2 is allowed to transmit the protection target information 210 to the information using apparatus 3. The distribution activation unit 24 sets, as this item, the upper limit of the number of times the information holding apparatus 2 is allowed to transmit the protection target information 210 to the information using apparatus 3. For example, the distribution activation unit 24 may set the upper limit of the number of times of transmission in conformity with the rule that is predetermined in accordance with the type of the protection target information 210, or may set the upper limit of the number of times of transmission in accordance with an upper limit of the number of times which upper limit is specified by the user. With reference to this item, the information holding apparatus 2 can determine up to how many times the information holding apparatus 2 is allowed to transmit the protection target information 210 to the information using apparatus 3.

The item “user electronic signature” indicates an electronic signature of the user which electronic signature has been added to the distribution consent data 110 from which a corresponding distribution permit derives. The information holding apparatus 2 can use a hash value stored in this item to confirm that “details of the distribution permit are certainly based on proper consent by the user”.

The item “distribution management apparatus electronic signature” indicates an electronic signature of the distribution management apparatus 1 which electronic signature is added to the distribution permit. The distribution activation unit 24 generates the distribution permit to which the electronic signature of the distribution management apparatus 1 is added, and transmits the distribution permit to the information holding apparatus 2. The information holding apparatus 2 can use a hash value stored in this item to confirm that “the distribution permit certainly has been transmitted from the distribution management apparatus 1, and details of the distribution permit have not been falsified”.

<Variation>

(Specific Example and Variation of Determination Unit 23)

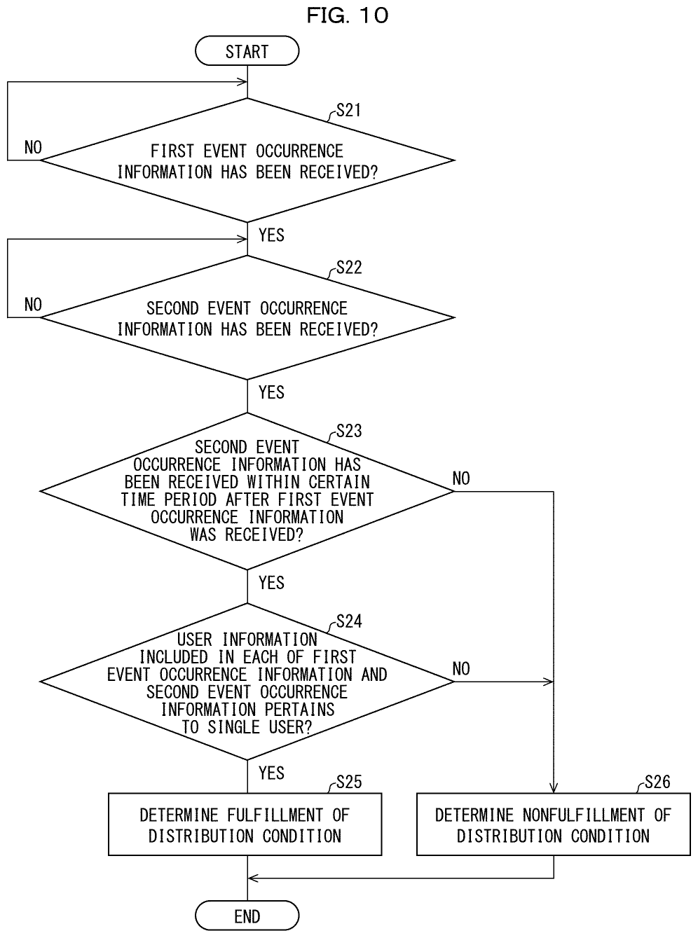

The following description will discuss, with reference to FIG. 10, a specific example of the fulfillment/nonfulfillment determination process for determining fulfillment or nonfulfillment of the distribution condition, the fulfillment/nonfulfillment process being carried out by the determination unit 23 in the step S107 illustrated in FIG. 8.

For example, in a case where a strong collision is detected by measured acceleration, the wearable terminal 5 may generate the first event occurrence information which gives notice that an event of a collision has occurred, and transmit the first event occurrence information to the distribution management apparatus 1. The first event occurrence information may include (i) the user information of the user who is a wearer of the wearable terminal 5, (ii) a date and time of detection of the collision, and (iii) a measured acceleration value.

From the public institution apparatus 233, the determination unit 23 may receive, as the second event occurrence information, the second event occurrence information which is information indicating that the user has encountered an accident, such as the accident certificate. The determination unit 23 may determine fulfillment of the distribution condition in accordance with the fact that the first event occurrence information indicating occurrence of the collision has been received from the wearable terminal 5 and the accident certificate has been received as the second event occurrence information from the public institution apparatus 233.

An example of the fulfillment/nonfulfillment determination process carried out by the determination unit 23 is illustrated by the drawings as below. FIG. 10 is a flowchart showing an example of a flow of the fulfillment/nonfulfillment determination process carried out by the determination unit 23 for determining fulfillment or nonfulfillment of the distribution condition.

In a step S21, the determination unit 23 determines whether the first event occurrence information, e.g., the impact detection notice has been received from the wearable terminal 5. In a case where the impact detection notice has been received, the determination unit 23 proceeds with the process from YES in S21 to S22.

In a step S22, the determination unit 23 determines whether the second event occurrence information, e.g., the accident certificate has been received from the public institution apparatus 233. In a case where the accident certificate has been received, the determination unit 23 proceeds with the process from YES in S22 to S23.

In a step S23, the determination unit 23 may determine a correlation or no correlation between two pieces of the event occurrence information in accordance with a temporal distance between the two pieces of the event occurrence information. For example, the determination unit 23 determines whether the second event occurrence information has been received within a certain time period after the first event occurrence information was received. In a case where dates and times of reception of the two pieces of the event occurrence information are close to each other, the determination unit 23 determines the correlation between the two pieces of the event occurrence information and proceeds with the process from YES in S23 to S24. In contrast, in a case where the dates and times of reception of the two pieces of the event occurrence information are apart from each other, the determination unit 23 determines no correlation between the two pieces of the event occurrence information and proceeds with the process from NO in S23 to S26.

In a step S24, the determination unit 23 may determine the correlation or no correlation between the two pieces of the event occurrence information by determining whether the two pieces of the event occurrence information derive from an incident that has happened to a single user. For example, the determination unit 23 determines whether pieces of the user information included in the first event occurrence information and the second event occurrence information, respectively, pertain to a single user. In a case where the respective pieces of the user information of the two pieces of the event occurrence information refer to a single user, the determination unit 23 determines the correlation between the two pieces of the event occurrence information and proceeds with the process from YES in S24 to S25. In contrast, in a case where the respective pieces of the user information of the two pieces of the event occurrence information refer to users different from each other, the determination unit 23 determines no correlation between the two pieces of the event occurrence information and proceeds with the process from YES in S24 to S26.

In a step S25, the determination unit 23 determines fulfillment of the distribution condition in response to reception of the two pieces of the event occurrence information which derive from a single incident that has happened to a single user. The determination unit 23 supplies a determination result to the distribution activation unit 24.

In a step S26, the determination unit 23 determines that the received two pieces of the event occurrence information derive from respective different incidents, and determines nonfulfillment of the distribution condition. The determination unit 23 supplies a determination result to the distribution activation unit 24.

As a more specific example, in the step S23, the determination unit 23 may compare the date and time of reception of the first event occurrence information with the date and time of reception of the second event occurrence information. In a case where the dates and times of reception of the two pieces of the event occurrence information are close to each other, e.g., not more than two to three days apart, in the step S25, the determination unit 23 may determine a correlation between these pieces of the event occurrence information and determine fulfillment of the distribution condition.

Alternatively, in the step S23, the determination unit 23 may compare (a) the date and time of detection of the collision, the date and time being indicated by the impact detection notice which is the first event occurrence information with (b) a “date and time of occurrence” included in the accident certificate which is the second event occurrence information. In a case where are the date and time of detection and the “date and time of occurrence” are close to each other, e.g., not more than half a day apart, the determination unit 23 may determine a correlation between these pieces of the event occurrence information and determine fulfillment of the distribution condition.

Further alternatively, in the step S24, the determination unit 23 may compare a “name of the wearer of the wearable terminal 5” included in the impact detection notice with a “name (of a party to the accident)” included in the accident certificate. In a case where the above-mentioned “name of the wearer” and the above-mentioned “name” refer to a single user, in the step S25, the determination unit 23 may determine a correlation between these pieces of the event occurrence information and determine fulfillment of the distribution condition.

(Another Variation of Determination Unit 23)

After receiving the first event occurrence information and while waiting for the second event occurrence information following the first event occurrence information, the determination unit 23 may extract in advance from the consent DB 1100 a group of pieces of the distribution consent data 110 which group corresponds to the first event occurrence information. This makes it possible, at the time of reception of the second event occurrence information, to quickly narrow down the pieces of the distribution consent data 110 which pieces fulfill the distribution condition. This enables distribution of information processing load or smoother information processing.

(Variation of Advance Notice Unit 25)

In order to further improve safety, the advance notice unit 25 may transmit, to the information using apparatus 3, a password together with the advance notice, the password allowing the protection target information 210 that is transmitted from the information holding apparatus 2 to be opened. With this, even in a case where the protection target information 210 that is transmitted from the information holding apparatus 2 accidentally reaches a different apparatus, only the information using apparatus 3 that is a proper receiver which possesses the password is allowed to open the protection target information 210, so that the protection target information 210 can be protected.

### Effect of Second Example Embodiment

It is considered that the user who suffers damage such as a traffic accident carries out various accident-related procedures such as a request for insurance and a consultation with a lawyer. In this case, parties concerned such as an insurance company and a law office require the user to submit various pieces of the protection target information pertaining to the user. Submission of the pieces of the protection target information one by one to the parties concerned is conventionally a burdensome task for the user. Furthermore, any deficiency in the protection target information that is prepared by the user results in a problem of a delay in various procedures without accurate information transmitted to the parties concerned. In a case where the parties concerned can directly exchange the protection target information of the user, an error in transmission of information may be reduced, but consent of the user is required every time the protection target information is exchanged. This still does not overcome complexity of the procedures for the user.

In contrast, the distribution management system 100 in accordance with the second example embodiment enables the distribution management apparatus 1 to understand fulfillment of the distribution condition in accordance with the fact that the user has suffered an accident. In response to fulfillment of the distribution condition, the distribution management apparatus 1 manages distribution of the protection target information 210 so that a required piece of the protection target information 210 is supplied from the information holding apparatus 2 to the information using apparatus 3 in accordance with the distribution consent data 110 which is registered in advance in the storage apparatus 11. Specifically, the distribution management apparatus 1 permits and instructs the information holding apparatus 2 to transmit a certain piece of the predetermined protection target information 210 to the information using apparatus 3. In this way, the information holding apparatus 2 transmits, to the information using apparatus 3, the protection target information 210 that is held by the information holding apparatus 2.

As described above, the protection target information 210 pertaining to the user and required for a procedure is accurately transmitted, at a required timing, from the information holding apparatus 2 that originally holds the protection target information 210 to the information using apparatus 3 that is the proper receiver of the protection target information 210. This reduces an error in transmission of information.

Furthermore, the user only needs to register, in the storage apparatus 11 once in advance of an emergency, prior consent regarding “at what time and to which information using apparatus 3 to send a corresponding piece(s) of the protection target information 210”. Thus, after the emergency, the user is relieved not only from a burdensome task of submitting the pieces of the protection target information one by one to the parties concerned but also from inconvenience of being requested for consent every time the pieces of the protection target information are exchanged.

In particular, in a case where the user has suffered an accident, the distribution management system 100 in accordance with the second example embodiment prevents the user from being required by the parties concerned to submit or consent one by one to the pieces of the protection target information. The distribution management system 100 enables the protection target information 210 to be smoothly distributed between the parties concerned. This enables the user to easily proceed with the procedures such as a request for insurance and a consultation with a lawyer.

Furthermore, information held by the distribution management apparatus 1 at a center of which distribution of the protection target information 210 is managed is the prior consent described earlier. In other words, the protection target information 210 per se does not need to be received from the user. This makes it possible to eliminate a psychological burden on the user such that the user does not wish to deposit, in an apparatus different from the information holding apparatus 2, the protection target information 210 which is important, or that deposition of the protection target information 210 involves risk and fear. This point is highly advantageous to the user in terms of making it easier to use the distribution management system 100.

### Third Example Embodiment

A third example embodiment of the present invention will be described in detail with reference to the drawings. Note that members having functions identical to those of the respective members described in the first and second example embodiments are given respective identical reference numerals, and a description of those members is not repeated.

<Configuration of Distribution Management System>

An overall configuration of a distribution management system 100 in accordance with a third example embodiment of the present invention is substantially similar to the distribution management system 100 illustrated in FIG. 5. A configuration different from the configuration of the distribution management system 100 of the second example embodiment will be described later in detail. The distribution management system 100 in accordance with the third example embodiment is applied as a system for allowing a user who has concluded a contract to purchase an automobile from a car dealer to appropriately distribute protection target information 210 of the user to parties concerned.

As in the case of the second example embodiment, the distribution management system 100 in accordance with the third example embodiment includes (i) at least one distribution subject apparatus 230 that functions as at least one of an information holding apparatus 2 and an information using apparatus 3, (iii) a storage apparatus 11, and (iii) a distribution management apparatus 1. The distribution management apparatus 1 may include the storage apparatus 11.

In the distribution management system 100 in accordance with the third example embodiment, the wearable terminal 5 need not be included as an external apparatus. An external apparatus 501 that is included in the distribution management system 100 is an in-vehicle communication terminal that is mounted in a purchased vehicle purchased by the user from the car dealer. The in-vehicle communication terminal is an apparatus capable of wirelessly communicating with a user apparatus 4 such as a smartphone via a wireless communication means such as Bluetooth (registered trademark). The in-vehicle communication terminal may be a car navigation system, an event data recorder, or the like. Upon completing a process for communication cooperation such as pairing with the user apparatus 4, the in-vehicle communication terminal transmits, to the distribution management apparatus 1, a communication cooperation completion notification as event occurrence information.

Furthermore, the distribution management system 100 in accordance with the third example embodiment includes an automobile insurance company apparatus as the external apparatus. The automobile insurance company apparatus belongs to an automobile insurance company that provides the user with automobile insurance-related service. The automobile insurance company apparatus transmits, to the distribution management apparatus 1, the event occurrence information that is a contract conclusion notification which gives notice of conclusion of a contract with the user for automobile insurance.

Examples of the at least one distribution subject apparatus 230 that is included in the distribution management system 100 in accordance with the third example embodiment include a car dealer apparatus, a police station apparatus, and a district transport bureau apparatus.

The car dealer apparatus, which belongs to the car dealer that sells a car to the user, prepares, as the protection target information 210, purchased vehicle information, which is information pertaining to the purchased vehicle, and holds the purchased vehicle information. Note that the car dealer apparatus also functions as the external apparatus. The car dealer apparatus transmits, to the distribution management apparatus 1, the event occurrence information that is the contract conclusion notification which gives notice of conclusion of an automobile sales contract with the user.

The police station apparatus, which belongs to a police station, prepares a parking certificate in accordance with the purchased vehicle information that has been prepared by the car dealer apparatus.

The district transport bureau apparatus, which belongs to a district transport bureau, carries out, in accordance with the parking certificate that has been prepared by the police station apparatus, various procedures such as a registration procedure with respect to the purchased vehicle of the user.

<Data Structure of Consent DB>

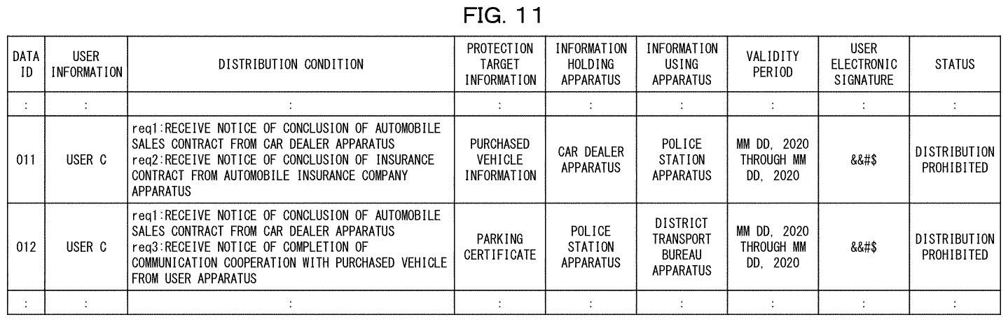

In the distribution management system 100 in accordance with the third example embodiment, a data structure of a consent DB 1100 that is stored in the storage apparatus 11 will be described with reference to FIG. 11. FIG. 11 is a data structure diagram illustrating an example of the data structure of the consent DB 1100.

The consent DB 1100 is, for example, configured to include the following items: the data ID, the user information, the distribution condition, the protection target information, the information holding apparatus, the information using apparatus, the validity period, the user electronic signature, and the status, which have been described in the first and second example embodiments described earlier.

In accordance with the distribution consent data 110 described in a record of the data ID “011”, a determination unit 23 of the distribution management apparatus 1 operates as below. Specifically, the determination unit 23 determines fulfillment of the distribution condition upon receiving, from the car dealer apparatus, the contract conclusion notification regarding automobile sales, and receiving, from the automobile insurance company apparatus, the contract conclusion notification regarding automobile insurance. In a case where names of contracting parties included in the respective two contract conclusion notifications refer to a single user “user C”, the determination unit 23 may determine a correlation between the two contract conclusion notifications and determine fulfillment of the distribution condition.

In accordance with the distribution consent data 110 of the data ID “011”, a distribution activation unit 24 activates distribution so that the purchased vehicle information will be transmitted from the car dealer apparatus to the police station apparatus. The distribution activation unit 24 may activate the status of the distribution consent data 110 from a distribution prohibited state to a distribution permitted state or generate a distribution permit that permits the car dealer apparatus to transmit the purchased vehicle information to the police station apparatus.

The distribution activation unit 24 that has activated distribution which is based on the distribution consent data 110 of the data ID “011” causes the car dealer apparatus to transmit the purchased vehicle information to the police station apparatus.

According to the distribution consent data 110 of the data ID “012”, the parking certificate is transmitted from the police station apparatus to the district transport bureau apparatus in a similar flow.

### Effect of Third Example Embodiment

In a case where the user has purchased an automobile, the distribution management system 100 in accordance with the third example embodiment enables smooth distribution of the protection target information 210 between the parties concerned while preventing the user from being required by the parties concerned to submit or consent one by one to pieces of the protection target information. This enables the user to easily proceed with procedures such as acquisition of the parking certificate and registration of the automobile.

### Fourth Example Embodiment

A fourth example embodiment of the present invention will be described in detail with reference to the drawings. Note that members having functions identical to those of the respective members described in the first to third example embodiments are given respective identical reference numerals, and a description of those members is not repeated.

<Configuration of Distribution Management System>

An overall configuration of a distribution management system 100 in accordance with a fourth example embodiment of the present invention is substantially similar to the distribution management system 100 illustrated in FIG. 5. A configuration different from the configuration of the distribution management system 100 of the second example embodiment will be described later in detail. The distribution management system 100 in accordance with the fourth example embodiment is applied as a system that allows a user who files a final tax return to appropriately distribute protection target information 210 of the user to parties concerned.

As in the case of the second example embodiment, the distribution management system 100 in accordance with the fourth example embodiment includes (i) at least one distribution subject apparatus 230 that functions as at least one of an information holding apparatus 2 and an information using apparatus 3, (iii) a storage apparatus 11, and (iii) a distribution management apparatus 1. The distribution management apparatus 1 may include the storage apparatus 11.

In the distribution management system 100 in accordance with the fourth example embodiment, examples of an external apparatus that supplies event occurrence information to the distribution management apparatus 1 include (i) a user apparatus 4, (ii) a medical institution apparatus 231 of a medical institution at which the user has received a consultation, and (iii) a bank apparatus of a bank that manages an account opened by the user.

The medical institution apparatus 231 that has issued a medical expenses receipt to the user to which the consultation was provided transmits, to the distribution management apparatus 1, the event occurrence information which is a consultation notification that gives notice of the fact that the user has received the consultation. In a case where the user has received the consultation at the medical institution and received the medical expenses receipt, in accordance with an operation by the user, the user apparatus 4 transmits, to the distribution management apparatus 1, the event occurrence information that is an approval with an electronic signature of the user for proving validity of the medical expenses receipt.

The bank apparatus which has confirmed that money was paid into a predetermined account of the user transmits, to the distribution management apparatus 1, the event occurrence information which is a payment confirmation notification that gives notice of confirmation of payment of money. In a case where the user has confirmed payment of money, in accordance with an operation by the user, the user apparatus 4 transmits, to the distribution management apparatus 1, the event occurrence information that is an approval with the electronic signature of the user for approving the fact of payment of money.

Examples of the at least one distribution subject apparatus 230 that is included in the distribution management system 100 in accordance with the fourth example embodiment include the medical institution apparatus 231, the bank apparatus, and a tax office apparatus.

The medical institution apparatus 231, which belongs to the medical institution at which the user has received the consultation, prepares and holds the medical expenses receipt as the protection target information 210.

The bank apparatus, which belongs to the bank that manages the account opened by the user, holds, as the protection target information 210, an amount of money paid into the account.

The tax office apparatus, which belongs to the tax office, carries out a procedure pertaining to the final tax return in accordance with an income of the user which income is calculated from the medical expenses receipt and the amount of money paid.

<Data Structure of Consent DB>

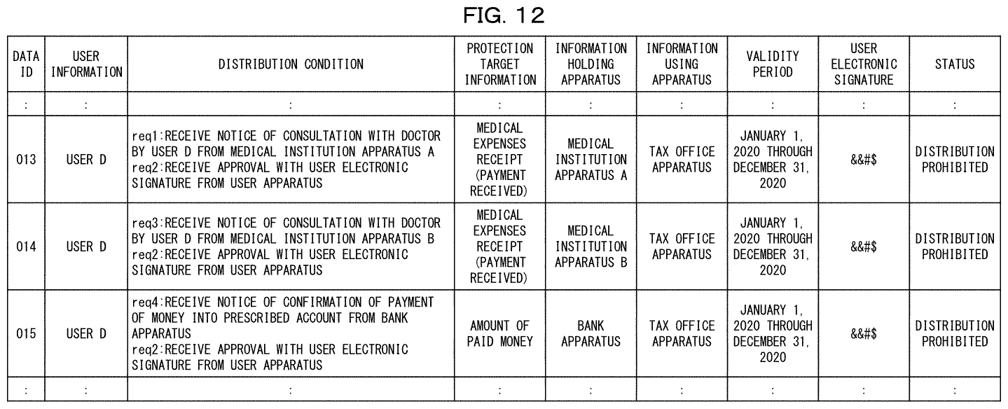

In the distribution management system 100 in accordance with the fourth example embodiment, a data structure of a consent DB 1100 that is stored in the storage apparatus 11 will be described with reference to FIG. 12. FIG. 12 is a data structure diagram illustrating an example of the data structure of the consent DB 1100.

The consent DB 1100 is, for example, configured to include the following items: the data ID, the user information, the distribution condition, the protection target information, the information holding apparatus, the information using apparatus, the validity period, the user electronic signature, and the status, which have been described in the first to third example embodiments described earlier. The medical expenses receipt is issued for each medical institution. Thus, in the fourth example embodiment, the distribution consent data 110 for consenting to distribution of the medical expenses receipt is registered for each medical institution that issues the medical expenses receipt. In the fourth example embodiment, the validity period of the distribution consent data 110 may be set to a period for filing of the final tax return.

In accordance with the distribution consent data 110 described in a record of the data ID “013”, a determination unit 23 of the distribution management apparatus 1 operates as below. Specifically, the determination unit 23 determines fulfillment of the distribution condition upon receiving, from a medical institution apparatus A, the consultation notification which gives notice of the fact that the user has received the consultation, and receiving, from the user apparatus 4, the approval with the electronic signature of the user (hereinafter, user approval), the approval indicating that the user has certainly received the consultation. The determination unit 23 compares a patient name included in the consultation notification with the user information associated with the user apparatus 4 that has transmitted the user approval. In a case where the patient name and the user information refer to a single user “user D”, the determination unit 23 may (i) determine a correlation between two pieces of the event occurrence information and (ii) determine fulfillment of the distribution condition.

In accordance with the distribution consent data 110 of the data ID “013”, a distribution activation unit 24 activates distribution so that the medical expenses receipt will be transmitted from the medical institution apparatus A to the tax office apparatus. The distribution activation unit 24 may activate the status of the distribution consent data 110 from a distribution prohibited state to a distribution permitted state or generate a distribution permit that permits the medical institution apparatus A to transmit the medical expenses receipt to the tax office apparatus.

The distribution activation unit 24 that has activated distribution which is based on the distribution consent data 110 of the data ID “013” causes the medical institution apparatus A to transmit the medical expenses receipt to the tax office apparatus.

According to the distribution consent data 110 of the data ID “015”, the amount of money paid, i.e., an amount of the income of the user is transmitted from the bank apparatus to the tax office apparatus in a similar flow.

### Effect of Fourth Example Embodiment

According to the distribution management system 100 in accordance with the fourth example embodiment, without the need to collect and store, for the final tax return, records of payment of medical expenses and obtainment of the income, the user can smoothly distribute these records as the protection target information 210 between the parties concerned. This enables the user to easily proceed with the procedure for the final tax return.

### Other Application Examples

The distribution management system 100 of the present disclosure is not limited to the example embodiments described above, and is applicable to various scenes of use in which scenes the user wishes to safely and smoothly distribute the protection target information 210. For example, the distribution management system 100 is applicable to a health management system and can be used to strengthen cooperation between the user and the medical institution.

Assume, for example, that the wearable terminal 5 as the information holding apparatus 2 holds, as the protection target information 210, an activity level (the number of steps, the number of steps climbed up and down, a distance traveled, the number of calories consumed, etc.) of the user and vital data (a heart rate, a blood pressure, a body temperature, a blood oxygen level, a body weight, etc.) of the user.

Assume also that the user has made an appointment for a consultation with a medical institution at which a family doctor is present. The medical institution apparatus 231 transmits, to the distribution management apparatus 1, the event occurrence information that is an appointment completion notification which gives notice of acceptance of the appointment for the consultation.

The distribution management apparatus 1 gives permission and an instruction to the wearable terminal 5 in accordance with the distribution consent data 110 that is registered in advance. Specifically, the distribution management apparatus 1 instructs the wearable terminal 5 to transmit, from the wearable terminal 5 to the medical institution apparatus 231, the activity level and the vital data of the user, which were measured in a certain period immediately before a date of appointment for the consultation.

This enables a medical professional to understand, by the day of the consultation, health management information of the user, who is a patient.

[Software Implementation Example]

Some or all of functions of the distribution management apparatus 1 can be realized by hardware provided in an integrated circuit (IC chip) or the like or can be alternatively realized by software.

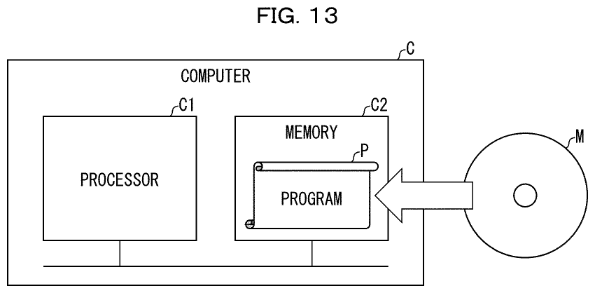

In the latter case, the distribution management apparatus 1 is realized by, for example, a computer that executes instructions of a program that is software realizing the foregoing functions. FIG. 13 illustrates an example of such a computer (hereinafter referred to as a “computer C”). The computer C includes at least one processor C1 and at least one memory C2. The at least one memory C2 stores a program P for causing the computer C to operate as the distribution management apparatus 1. In the computer C, the at least one processor C1 reads and executes the program P stored in the at least one memory C2, so that the functions of the distribution management apparatus 1 are realized.

Examples of the at least one processor C1 encompass a central processing unit (CPU), a graphic processing unit (GPU), a digital signal processor (DSP), a micro processing unit (MPU), an floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is to be loaded while being executed and in which various kinds of data are to be temporarily stored. The computer C may further include a communication interface through which data is to be transmitted and received between the computer C and at least one other apparatus. The computer C may further include an input/output interface through which an input/output device(s) such as a keyboard, a mouse, a display and/or a printer is/are to be connected to the computer C.

The program P can be recorded in a non-transitory, tangible storage medium M capable of being read by the computer C. Examples of such a storage medium M encompass a tape, a disk, a card, a semiconductor memory, and a programmable logic circuit. The computer C can acquire the program P via the storage medium M. The program P can alternatively be transmitted via a transmission medium. Examples of such a transmission medium encompass a communication network and a broadcast wave. The computer C can alternatively acquire the program P via the transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary Note 1)

A distribution management apparatus including: an acquisition means that acquires distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and a distribution activation means that, in a case where the distribution condition which is indicated by the acquired distribution consent data is fulfilled, permits the information holding apparatus to transmit the protection target information to the information using apparatus.

According to the above configuration, in response to fulfillment of the distribution condition, the distribution management apparatus gives permission, in accordance with the distribution consent data, for transmission of a required piece of the protection target information from the information holding apparatus to the information using apparatus. In accordance with the permission, the protection target information is transmitted from the information holding apparatus to the information using apparatus.

The protection target information is not held in the distribution management apparatus, but is held in the information holding apparatus, which is a place where the protection target information is originally kept. In other words, the user does not need to deposit an important piece of the protection target information in the distribution management apparatus. This allows the user to escape a risk of leakage of the protection target information. As a result, information to be protected can be appropriately distributed without any psychological burden on the user who fears the risk.

(Supplementary Note 2)

A distribution management apparatus according to Supplementary note 1, further including a determination means that determines fulfillment or nonfulfillment of the distribution condition in accordance with at least one piece of event occurrence information which has been transmitted from one or more external apparatuses and which gives notice of occurrence of an event.

The above configuration makes it possible to accurately understand, as a system, an incident that happens to the user, and to appropriately distribute the protection target information at a required timing.

(Supplementary Note 3)

The distribution management apparatus according to Supplementary note 2, wherein the determination means determines fulfillment of the distribution condition in a case where two or more pieces of the at least one piece of event occurrence information, the two or more pieces having been received from the respective one or more external apparatuses, are correlated with each other.

The above configuration makes it possible to more accurately understand, in accordance with a plurality of correlated events, the incident that happens to the user. It is possible to avoid accidentally distributing the protection target information at a timing at which the protection target information should not be distributed, and to ensure safer and appropriate distribution of the protection target information at a required timing.

(Supplementary Note 4)

The distribution management apparatus according to Supplementary note 3, wherein the determination means determines fulfillment of the distribution condition in a case where first event occurrence information is received and second event occurrence information is received within a certain time period after the first event occurrence information is received.

According to the above configuration, in accordance with the fact that a plurality of pieces of the event occurrence information have occurred within a short period of time, it is confirmed that these pieces of the event occurrence information have been generated due to a single incident which happened to the user. This makes it possible to more accurately understand the incident that happens to the user, and to appropriately distribute the protection target information.

(Supplementary Note 5)

The distribution management apparatus according to Supplementary note 3 or 4, wherein the determination means determines fulfillment of the distribution condition in a case where pieces of user information specific to the user and included in first event occurrence information and second event occurrence information, respectively, refer to a single user.

According to the above configuration, in accordance with the fact that the pieces of the user information included in the respective plurality of pieces of the event occurrence information refer to a single user, it is confirmed that these pieces of the event occurrence information have been generated due to an incident which happened to a single user. This makes it possible to more accurately understand the incident that happens to the user, and to appropriately distribute the protection target information.

(Supplementary Note 6)

The distribution management apparatus according to any one of Supplementary notes 2 to 5, wherein at least one of the one or more external apparatuses is a wearable terminal that is worn by the user, and the event occurrence information that is transmitted from the wearable terminal includes a physical quantity measured by the wearable terminal.

The above configuration makes it possible to more accurately understand, in accordance with an objective physical quantity measured with respect to the user, the incident that happens to the user. This makes it possible to more accurately understand the incident that happens to the user, and to appropriately distribute the protection target information.

(Supplementary Note 7)

The distribution management apparatus according to any one of Supplementary notes 1 to 6, wherein in a case where the distribution condition is fulfilled, the distribution activation means updates a status of the distribution consent data from a distribution prohibited state to a distribution permitted state, the distribution prohibited state indicating that transmission of the protection target information is prohibited, the distribution permitted state indicating that transmission of the protection target information is permitted, and upon receiving, from the information holding apparatus or the information using apparatus, a request for permission to distribute the protection target information, in a case where the status of the distribution consent data of the protection target information indicates the distribution permitted state, the distribution activation means permits the information holding apparatus to transmit the protection target information to the information using apparatus.

According to the above configuration, in response to a request from a distribution subject apparatus that provides/receives the protection target information, it is possible to distribute the protection target information, at an appropriate timing, to an information using apparatus that requires the protection target information.

(Supplementary Note 8)

The distribution management apparatus according to any one of Supplementary notes 1 to 6, wherein in a case where the distribution condition is fulfilled, the distribution activation means transmits, to the information holding apparatus, a distribution permit that permits transmission of the protection target information to the information using apparatus.

According to the above configuration, in accordance with (i) detection of occurrence of a certain event and (ii) fulfillment of the distribution condition, it is possible to distribute the protection target information, at an appropriate timing, to the information using apparatus that should receive the protection target information.

(Supplementary Note 9)

The distribution management apparatus according to Supplementary note 7 or 8, wherein the distribution activation means sets a transmission period in which the information holding apparatus is allowed to transmit the protection target information.

According to the above configuration, after transmission of the protection target information is permitted, distribution of the protection target information is managed so that the protection target information is supplied from the information holding apparatus to the information using apparatus without delay at a timing at which exchange of the protection target information is meaningful. Furthermore, even after the protection target information is not required, it is possible to avoid a state in which transmission of the protection target information is unnecessarily permitted, and to safely protect the protection target information.

(Supplementary Note 10)

The distribution management apparatus according to any one of Supplementary notes 7 to 9, wherein the distribution activation means sets an upper limit of the number of times the information holding apparatus is allowed to transmit the protection target information.

The above configuration makes it possible to avoid a state in which the protection target information can be unnecessarily transmitted without any restriction, and to safely protect the protection target information.

(Supplementary Note 11)

A distribution management apparatus according to any one of Supplementary notes 1 to 10, further including a registration means that upon receiving, from a user apparatus operated by the user, a notification that the user consents to the information holding apparatus transmitting the protection target information to the information using apparatus in a case where the distribution condition is fulfilled, registers the distribution consent data in a storage apparatus before the distribution condition is fulfilled.

According to the above configuration, the user can register the distribution consent data in advance by a simple operation before an incident occurs that actually requires distribution of the protection target information.

(Supplementary Note 12)

The distribution management apparatus according to Supplementary note 11, wherein the registration means registers, in association with the distribution consent data, a validity period in which the distribution activation means is allowed to permit transmission of the protection target information.

According to the above configuration, permission is issued to the information holding apparatus for transmission of the protection target information only in a validity period that is suitable to distribute the protection target information. This makes it possible to prevent the protection target information from being distributed at an inappropriate timing, and to safely protect the protection target information.

(Supplementary Note 13)

A distribution management apparatus according to any one of Supplementary notes 1 to 12, further including an advance notice means that in response to permission by the distribution activation means for transmission of the protection target information, gives the information using apparatus advance notice that the protection target information will be transmitted from the information holding apparatus.

The above configuration enables the information using apparatus to know in advance that the protection target information, which is required in the event of an emergency, will be transmitted from the information holding apparatus, and to safely receive the protection target information and smoothly proceed with a procedure.

(Supplementary Note 14)

A distribution management apparatus according to any one of Supplementary notes 1 to 13, further including an information protection means that cancels permission for transmission of the protection target information in a case where a reception completion notification indicating that the protection target information has been received is not received from the information using apparatus within a certain time period after the distribution activation means permits the information holding apparatus to transmit the protection target information.

An attack (falsification, spoofing, or the like) on communication between the distribution management apparatus and the information holding apparatus or between the information holding apparatus and the information using apparatus may prevent safe exchange of the protection target information. According to the above configuration, in a case where the protection target information fails to be safely supplied to the information using apparatus within a certain time period, the distribution management apparatus deactivates distribution of the protection target information so as to prevent the information holding apparatus from transmitting the protection target information. Thus, it is possible to improve safety of distribution of the protection target information.

(Supplementary Note 15)

A distribution management apparatus according to any one of Supplementary notes 1 to 14, further including a reporting means that in response to the distribution activation means having permitted the information holding apparatus to transmit the protection target information, reports, to a user apparatus operated by the user, that transmission of the protection target information has been permitted.

The above configuration enables the user to know that distribution has been permitted. By receiving a report, the user may take some action in a case where permission for distribution is inappropriate. This makes it possible not only to eliminate a feeling of uneasiness toward distribution of the protection target information without the user's knowledge, but also to give the user a feeling of security that the protection target information is being appropriately distributed.

(Supplementary Note 16)

A distribution management system including: an information holding apparatus that holds protection target information, which pertains to a user and is to be protected; an information using apparatus that uses the protection target information; a storage apparatus that stores distribution consent data indicating that the user consents to the information holding apparatus transmitting the protection target information to the information using apparatus in a case where a distribution condition, which is predetermined, is fulfilled; and a distribution management apparatus, the distribution management apparatus including: an acquisition means that acquires the distribution consent data from the storage apparatus; and a distribution activation means that, in a case where the distribution condition which is indicated by the distribution consent data is fulfilled, permits the information holding apparatus to transmit the protection target information to the information using apparatus.

The above configuration brings about an effect similar to that brought about by Supplementary note 1.

(Supplementary Note 17)

A distribution management system according to Supplementary note 16, further including a wearable terminal worn by the user, the wearable terminal transmitting, to the distribution management apparatus, event occurrence information that gives notice of occurrence of an event, the occurrence having been detected in accordance with a physical quantity measured by the wearable terminal, the distribution management apparatus further including a determination means that determines fulfillment or nonfulfillment of the distribution condition in accordance with the event occurrence information which has been transmitted from the wearable terminal.

The above configuration brings about an effect similar to that brought about by Supplementary note 6.

(Supplementary Note 18)

A distribution management system according to Supplementary note 16 or 17, further including a user apparatus operated by the user, the user apparatus including: an input assistance means that causes the user to give an answer as to whether the user will give consent to the information holding apparatus transmitting the protection target information to the information using apparatus in a case where the distribution condition is fulfilled; and a registration means that, in a case where the input assistance means receives, from the user, an answer indicating that the user gives consent, registers the distribution consent data in the storage apparatus before the distribution condition is fulfilled.

The above configuration brings about an effect similar to that brought about by Supplementary note 11.

(Supplementary Note 19)

A distribution management method wherein: a distribution management apparatus acquires distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and in a case where the distribution condition which is indicated by the acquired distribution consent data is fulfilled, the distribution management apparatus permits the information holding apparatus to transmit the protection target information to the information using apparatus.

The method described above brings about an effect similar to that brought about by Supplementary note 1.

(Supplementary Note 20) A control program for causing a computer to operate as the distribution management apparatus according to any one of Supplementary notes 1 to 15, the control program causing the computer to function as each of the foregoing means.

The above configuration brings about an effect similar to that brought about by Supplementary note 1.

(Supplementary Note 21)

A non-transitory, tangible computer-readable storage medium storing therein the control program according to Supplementary note 20.

The above configuration brings about an effect similar to that brought about by Supplementary note 1.

[Additional Remark 3]

Furthermore, the whole or part of the example embodiments disclosed above can also be expressed as below.

A distribution management apparatus including at least one processor, the at least one processor carrying out: an acquisition process for acquiring distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and a distribution activation process for, in a case where the distribution condition which is indicated by the acquired distribution consent data is fulfilled, permitting the information holding apparatus to transmit the protection target information to the information using apparatus.

Note that the distribution management apparatus may further include a memory, which may store a program for causing the at least one processor to carry out the acquisition process and the distribution activation process. Furthermore, the program may be recorded in a non-transitory, tangible computer-readable storage medium.

### REFERENCE SIGNS LIST

1 Distribution management apparatus
2 Information holding apparatus
3 Information using apparatus
4 User apparatus
5 Wearable terminal
10 Control apparatus
11 Storage apparatus
21 Registration unit
22 Acquisition unit
23 Determination unit
24 Distribution activation unit
25 Advance notice unit
26 Information protection unit
27 Reporting unit
41 Input assistance unit
42 Transmission unit
100 Distribution management system
110 Distribution consent data
210 Protection target information
23 Distribution subject apparatus
501 External apparatus
1100 Distribution consent database

What is claimed is:

1. A distribution management apparatus comprising at least one processor, the at least one processor carrying out:
an acquisition process for acquiring distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and
a distribution activation process for, in a case where the distribution condition which is indicated by the acquired distribution consent data is fulfilled, permitting the information holding apparatus to transmit the protection target information to the information using apparatus.

2. The distribution management apparatus according to claim 1, wherein the at least one processor further carries out a determination process for determining fulfillment or nonfulfillment of the distribution condition in accordance with at least one piece of event occurrence information which has been transmitted from one or more external apparatuses and which gives notice of occurrence of an event.

3. The distribution management apparatus according to claim 2, wherein in the determination process, the at least one processor determines fulfillment of the distribution condition in a case where two or more pieces of the at least one piece of event occurrence information, the two or more pieces having been received from the respective one or more external apparatuses, are correlated with each other.

4. The distribution management apparatus according to claim 3, wherein in the determination process, the at least one processor determines fulfillment of the distribution condition in a case where first event occurrence information is received and second event occurrence information is received within a certain time period after the first event occurrence information is received.

5. The distribution management apparatus according to claim 3, wherein in the determination process, the at least one processor determines fulfillment of the distribution condition in a case where pieces of user information specific to the user and included in first event occurrence information and second event occurrence information, respectively, refer to a single user.

6. The distribution management apparatus according to claim 2, wherein at least one of the one or more external apparatuses is a wearable terminal that is worn by the user, and the event occurrence information that is transmitted from the wearable terminal includes a physical quantity measured by the wearable terminal.

7. The distribution management apparatus according to claim 1, wherein
in a case where the distribution condition is fulfilled, in the distribution activation process, the at least one processor updates a status of the distribution consent data from a distribution prohibited state to a distribution permitted state, the distribution prohibited state indicating that transmission of the protection target information is prohibited, the distribution permitted state indicating that transmission of the protection target information is permitted, and
upon receiving, from the information holding apparatus or the information using apparatus, a request for permission to distribute the protection target information, in a case where the status of the distribution consent data of the protection target information indicates the distribution permitted state, the at least one processor permits the information holding apparatus is permitted to transmit the protection target information to the information using apparatus.

8. The distribution management apparatus according to claim 1, wherein in a case where the distribution condition is fulfilled, in the distribution activation process, the at least one processor transmits, to the information holding apparatus, a distribution permit that permits transmission of the protection target information to the information using apparatus.

9. The distribution management apparatus according to claim 7, wherein in the distribution activation process, the at least one processor sets a transmission period in which the information holding apparatus is allowed to transmit the protection target information.

10. The distribution management apparatus according to claim 7, wherein in the distribution activation process, the at least one processor sets an upper limit of the number of times the information holding apparatus is allowed to transmit the protection target information.

11. The A-distribution management apparatus according to according to claim 1, wherein the at least one processor further carries out comprising a registration process for upon receiving, from a user apparatus operated by the user, a notification that the user consents to the information holding apparatus transmitting the protection target information to the information using apparatus in a case where the distribution condition is fulfilled, registering the distribution consent data in a storage apparatus before the distribution condition is fulfilled.

12. The distribution management apparatus according to claim 11, wherein in the registration process, the at least one processor registers, in association with the distribution consent data, a validity period in which the at least one processor is allowed in the distribution activation process to permit transmission of the protection target information.

13. The distribution management apparatus according to claim 1, wherein the at least one processor further carries out an advance notice process for in response to permission by the at least one processor in the distribution activation process for transmission of the protection target information, giving the information using apparatus advance notice that the protection target information will be transmitted from the information holding apparatus.

14. The distribution management apparatus according to claim 1, wherein the at least one processor further carries out an information protection process for cancelling permission for transmission of the protection target information in a case where a reception completion notification indicating that the protection target information has been received is not received from the information using apparatus within a certain time period after the at least one processor the information holding apparatus in the distribution activation process to transmit the protection target information.

15. The distribution management apparatus according to claim 1, wherein the at least one processor further carries out a reporting process for in response to the at least one processor having permitted the information holding apparatus in the distribution activation process to transmit the protection target information, reporting, to a user apparatus operated by the user, that transmission of the protection target information has been permitted.

16. A distribution management system comprising:
an information holding apparatus that holds protection target information, which pertains to a user and is to be protected;
an information using apparatus that uses the protection target information;
a storage apparatus that stores distribution consent data indicating that the user consents to the information holding apparatus transmitting the protection target information to the information using apparatus in a case where a distribution condition, which is predetermined, is fulfilled; and
a distribution management apparatus,
the distribution management apparatus including at least one processor, the at least one processor carrying out:
an acquisition process for acquiring the distribution consent data from the storage apparatus; and
a distribution activation process for, in a case where the distribution condition which is indicated by the distribution consent data is fulfilled, permitting the information holding apparatus to transmit the protection target information to the information using apparatus.

17. A distribution management system according to claim 16, further comprising a wearable terminal worn by the user,
the wearable terminal transmitting, to the distribution management apparatus, event occurrence information that gives notice of occurrence of an event, the occurrence having been detected in accordance with a physical quantity measured by the wearable terminal, wherein
the at least one processor included in the distribution management apparatus further carries out a determination process for determining fulfillment or nonfulfillment of the distribution condition in accordance with the event occurrence information which has been transmitted from the wearable terminal.

18. A distribution management system according to claim 16, further comprising a user apparatus operated by the user,
the user apparatus including at least one processor, the at least one processor carrying out:
an input assistance process for causing the user to give an answer as to whether the user will give consent to the information holding apparatus transmitting the protection target information to the information using apparatus in a case where the distribution condition is fulfilled; and
a registration process for, in a case where the at least one processor receives, from the user, an answer indicating that the user gives consent, registering the distribution consent data in the storage apparatus before the distribution condition is fulfilled.

19. A distribution management method wherein:
a distribution management apparatus acquires distribution consent data indicating that a user consents to an information holding apparatus transmitting, in a case where a distribution condition, which is predetermined, is fulfilled, protection target information to an information using apparatus that uses the protection target information, the information holding apparatus holding the protection target information, which pertains to the user and is to be protected; and
in a case where the distribution condition which is indicated by the acquired distribution consent data is fulfilled, the distribution management apparatus permits the information holding apparatus to transmit the protection target information to the information using apparatus.

20. A non-transitory, tangible computer-readable storage medium storing therein a program for causing a computer to operate as a distribution management apparatus according to claim 1, the program causing the computer to carry out each of the foregoing processes.
